(19) United States
(12) Patent Application Publication
(10) Pub. No.: US 2024/0419308 A1
(43) Pub. Date: Dec. 19, 2024

(54) Devices, Methods, and User Interfaces for Sharing Content Between Electronic Devices

(71) Applicant: Apple Inc., Cupertino, CA (US)

(72) Inventors: Jae Woo Chang, Cupertino, CA (US); Mayura D. Deshpande, San Carlos, CA (US); Chanaka G. Karunamuni, San Jose, CA (US); William M. Tyler, San Francisco, CA (US); Hope R. Hyun, San Jose, CA (US); Marcel van Os, Santa Cruz, CA (US); Jason Orlovich, San Francisco, CA (US); Miranda J. Zhou, San Jose, CA (US); Grant R. Paul, San Francisco, CA (US); Alejandro A. Rodriguez, Saratoga, CA (US); Pablo Pons Bordes, Redwood City, CA (US); Ryan A. Williams, Morgan Hill, CA (US); Charles Circlaeys, San Francisco, CA (US); Sreekuttan Sudarsanan, San Francisco, CA (US); Eric Lance Wilson, San Jose, CA (US); Christopher P. Foss, San Francisco, CA (US); Raymond S. Sepulveda, Portland, OR (US); Chun Kin Minor Wong, Portland, OR (US); Mani Amini, Santa Cruz, CA (US); Craig M. Federighi, Los Altos Hills, CA (US)

(21) Appl. No.: 18/652,606

(22) Filed: May 1, 2024

Related U.S. Application Data
(60) Provisional application No. 63/464,488, filed on May 5, 2023.

(51) Int. Cl. G06F 3/0484; G06F 3/14

(52) U.S. Cl. CPC G06F 3/0484; G06F 3/1454

(57) ABSTRACT

An electronic device that includes or is in communication with a display generation component detects a first input that corresponds to a request to initiate a process for sharing first content. In response to detecting the first input, the electronic device causes display of a sharing interface via the display generation component. Displaying the sharing interface includes concurrently displaying one or more sharing options for sharing content with other devices and instructions for sharing content using a proximity-initiated sharing mode.

### RELATED APPLICATIONS

This application claims priority to U.S. Provisional Patent Application No. 63/464,488, filed May 5, 2023, which is hereby incorporated by reference in its entirety.

### TECHNICAL FIELD

This relates generally to sharing content between electronic devices, including but not limited to, local and proximity-initiated content sharing between electronic devices.

### BACKGROUND

Sharing content between devices is widely used. But conventional methods of sharing content are cumbersome, inefficient, and limited. In some cases, the shared content is not easily accessible to a user after the transfer is completed. For example, the shared content is stored in a folder within the operating system and the user must navigate through several user interfaces into order to find the stored content and view it. In some cases, content is able to be shared via a local connection, but initiating such a process is unintuitive and requires navigation through multiple user interfaces. In some cases, a device can broadcast its availability to share content with other nearby devices. However, such broadcasting can pose a security and/or privacy risk for the user, particularly if they neglect to disable it expeditiously after use. In some cases, users are able to share contact information with other users, but the process to do so is unintuitive and requires navigation through multiple user interfaces.

In addition, conventional methods take longer and require more user interaction than necessary to adjust audio input/outputs and/or connectivity of the audio output devices, thereby wasting energy and providing an inefficient human-machine interface. Conserving device energy is particularly important in battery-operated devices.

### SUMMARY

Accordingly, there is a need for electronic devices with faster, more efficient methods and interfaces for sharing content between electronic devices. Such methods and interfaces optionally complement or replace conventional methods for sharing content. Such methods and interfaces reduce the cognitive burden on a user and produce a more efficient human-machine interface. For battery-operated devices, such methods and interfaces conserve power and increase the time between battery charges.

The above deficiencies and other problems associated with user interfaces for electronic devices are reduced or eliminated by the disclosed computer systems, e.g., which enable a user to send content to and receive content from other users by performing fewer steps in simpler user interfaces. In some embodiments, the computer system includes a desktop computer. In some embodiments, the computer system is portable (e.g., a notebook computer, tablet computer, or handheld device). In some embodiments, the computer system includes a personal electronic device (e.g., a wearable electronic device, such as a watch). In some embodiments, the computer system includes (and/or is in communication with) the wearable audio output devices (e.g., in-ear earphones, earbuds, over-ear headphones, etc.). In some embodiments, the computer system has (and/or is in communication with) a touch-sensitive surface (e.g., a “touchpad”). In some embodiments, the computer system has (and/or is in communication with) a display device, which in some embodiments is a touch-sensitive display (also known as a “touch screen” or “touch-screen display”). In some embodiments, the computer system has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, audio output device pairing and calibration, digital music/audio playing, note taking, and/or digital video playing. Executable instructions for performing these functions are, optionally, included in a non-transitory computer readable storage medium or other computer program product configured for execution by one or more processors.

In accordance with some embodiments, a method is performed at a first electronic device that includes or is in communication with a display generation component. The method includes receiving a transfer of respective content from a second electronic device via a local connection. The method further includes, in response to completion of the transfer of the respective content and in accordance with a determination that the transfer meets one or more transfer magnitude criteria, automatically causing display of at least a portion of the respective content via the display generation component. The method also includes in response to completion the transfer of the respective content and in accordance with a determination that the transfer does not meet the one or more transfer magnitude criteria, forgoing automatically causing display of the at least a portion of the respective content via the display generation component.

In accordance with some embodiments, a method is performed at an electronic device that includes or is in communication with a display generation component. The method includes detecting a first input that corresponds to a request to initiate a process for sharing first content. The method further includes, in response to detecting the first input, causing display of a sharing interface via the display generation component. Displaying the sharing interface includes concurrently displaying one or more sharing options for sharing content with other devices and instructions for sharing content using a proximity-initiated sharing mode.

In accordance with some embodiments, a method is performed at a first electronic device that includes or is in communication with a display generation component. The method includes detecting a user input corresponding to a request to make the first electronic device available for local sharing of content. The method further includes, in response to detecting the user input, broadcasting availability of the first electronic device for the local sharing of content and, while broadcasting the availability, receiving a communication from a second electronic device, the communication indicating that the second electronic device would like to participate in local sharing of content with the first electronic device. The method also includes, in response to receiving the communication from the second electronic device, causing display of a share option via the display generation component, where the share option is selectable to initiate a process for sharing content with the second electronic device via the local sharing of content. The method further includes, without further user input, ceasing to broadcast the availability of the first electronic device for local sharing of content.

In accordance with some embodiments, a method is performed at a first electronic device that includes or is in communication with a display generation component. The method includes detecting a request to initiate a process for sharing one or more content items from the first electronic device to a second electronic device. The method further includes, in response to the request to initiate the process for sharing the one or more content items, initiating the process to share the one or more content items between the first electronic device and a second electronic device. The method also includes, after sharing at least a portion of the one or more content items based on the request to initiate the process for sharing the one or more content items: in accordance with a determination that one or more contact sharing criteria are met, causing display, via the display generation component, of an option to share contact information with the second electronic device, the contact information corresponding to a user of the first electronic device; and, in accordance with a determination that one or more contact sharing criteria are not met, forgoing causing display, via the display generation component, of the option to share the contact information with the second electronic device.

In accordance with some embodiments, an electronic device (e.g., a multifunction device, an audio output device, or other type of electronic device) includes one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device cause the device to perform or cause performance of the operations of any of the methods described herein. In accordance with some embodiments, a graphical user interface on an electronic device with a display, a touch-sensitive surface, a memory, and one or more processors to execute one or more programs stored in the memory includes one or more of the elements displayed in any of the methods described herein, which are updated in response to inputs, as described in any of the methods described herein. In accordance with some embodiments, an electronic device includes means for performing or causing performance of the operations of any of the methods described herein. In accordance with some embodiments, an information processing apparatus, for use in an electronic device includes means for performing or causing performance of the operations of any of the methods described herein.

Thus, electronic devices with displays and/or touch-sensitive surfaces are provided with faster, more efficient methods and interfaces for sharing content, thereby increasing the effectiveness, efficiency, and user satisfaction with such devices. Such methods and interfaces may complement or replace conventional methods for sharing content.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3 is a block diagram of an example multifunction device with a display and a touch-sensitive surface in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5J illustrate example user interfaces and user interactions for broadcasting sharing availability and initiating local sharing of content in accordance with some embodiments.

FIGS. 5K-5Q illustrate example user interfaces and user interactions for proximity-initiated sharing of content in accordance with some embodiments.

FIGS. 5R-5T illustrate example user interfaces and user interactions for broadcasting sharing availability and initiating local sharing of content in accordance with some embodiments.

FIGS. 6A-6N illustrate example user interfaces and user interactions for sharing content and viewing shared content in accordance with some embodiments.

FIGS. 7A-7I illustrate example user interfaces and user interactions for sharing contact information in accordance with some embodiments.

FIGS. 8A-8C are flow diagrams of a process for displaying shared content in accordance with some embodiments.

FIGS. 9A-9C are flow diagrams of a process for proximity-initiated content sharing in accordance with some embodiments.

FIGS. 10A-10B are flow diagrams of a process for broadcasting sharing availability in accordance with some embodiments.

FIGS. 11A-11C are flow diagrams of a process for sharing contact information in accordance with some embodiments.

### DESCRIPTION OF EMBODIMENTS

Many electronic devices have graphical user interfaces with the ability to send content to a third party. The devices and processes described below improve on these methods. For example, embodiments disclosed herein describe improved processes and user interfaces for broadcasting availability, initiating content sharing, viewing shared content after transfer, and sharing contact information. These processes and user interfaces provide a simple and intuitive way to share content between two devices by eliminating extraneous user interface navigation operations, sharing configuration operations and other operations that are confusing, time consuming for a user, and/or a security/privacy risk. The simpler and more intuitive sharing of content improves the user experience, reduces operation time and improves battery life for batter powered devices.

The processes described below enhance the operability of devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

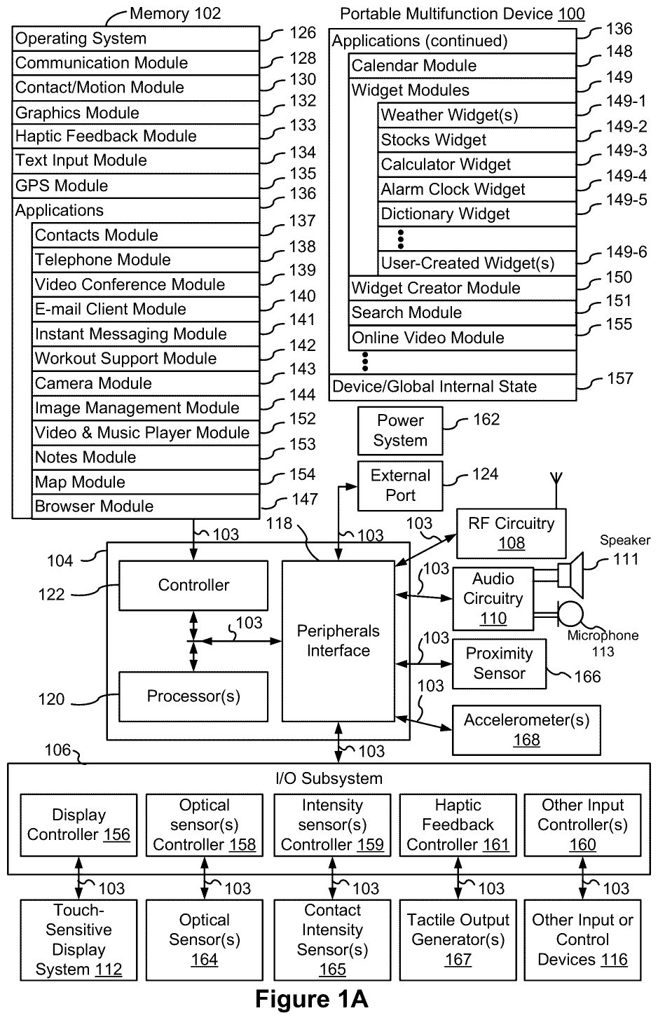

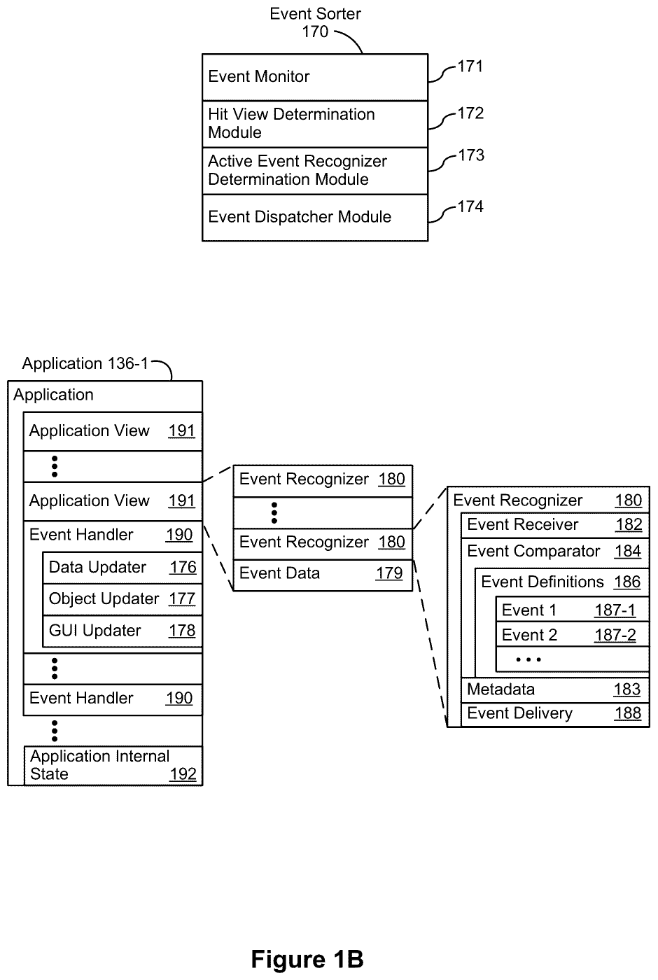

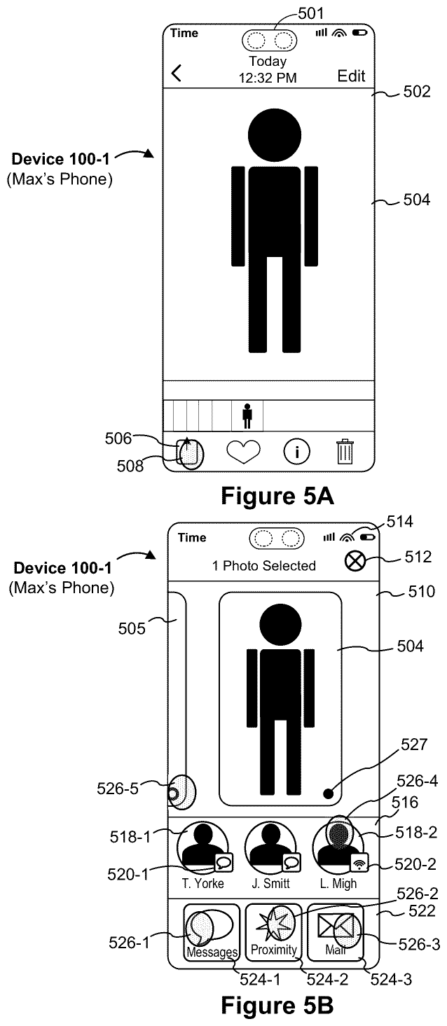

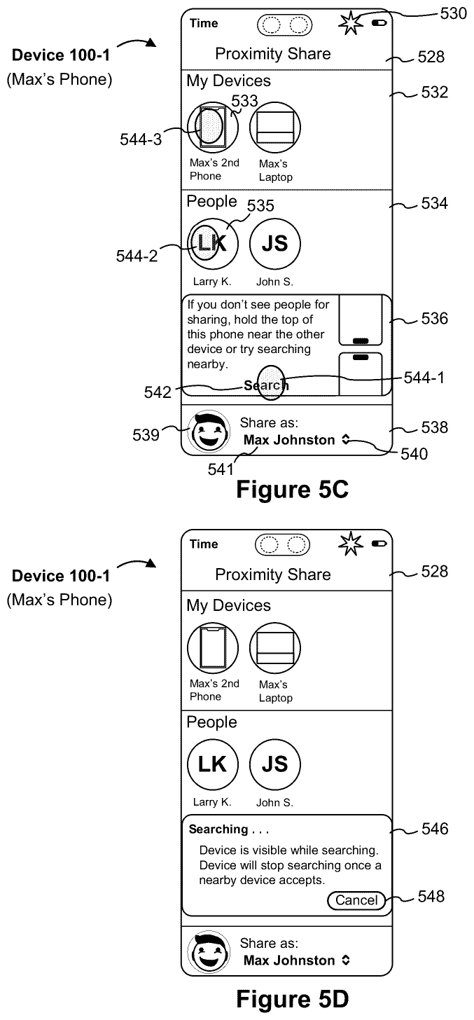

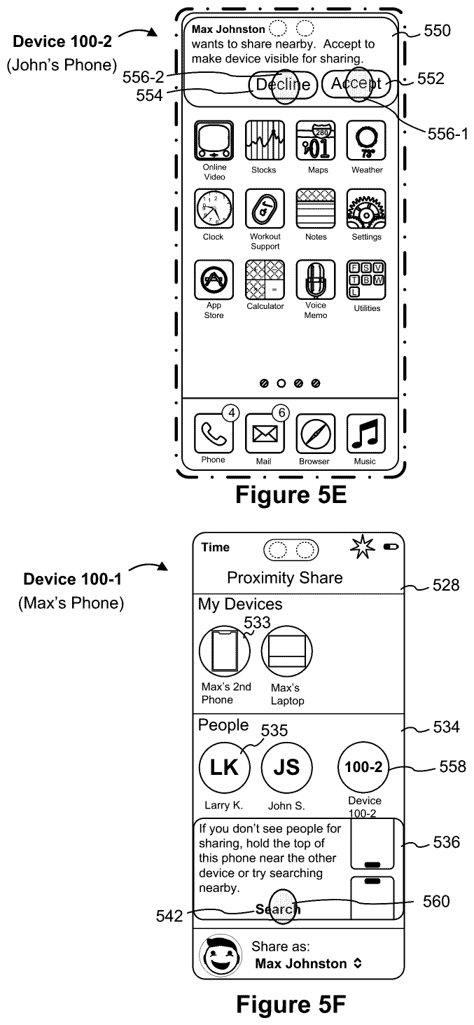

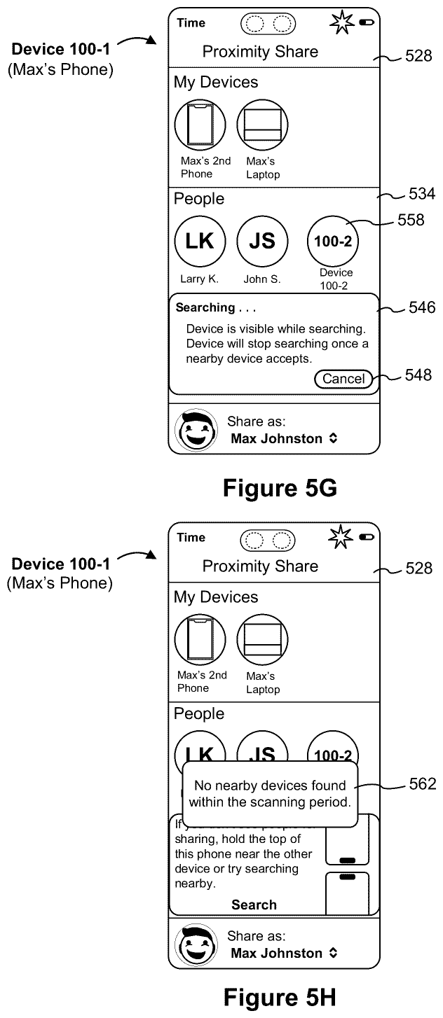

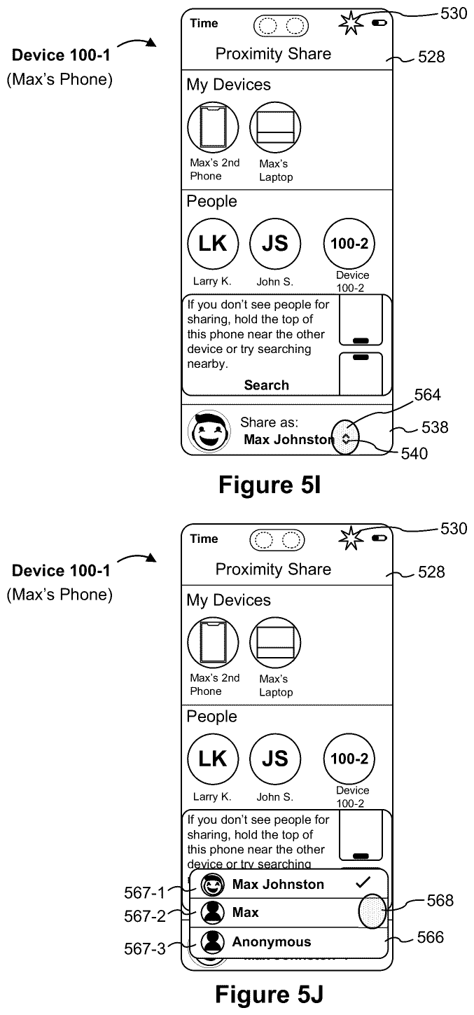

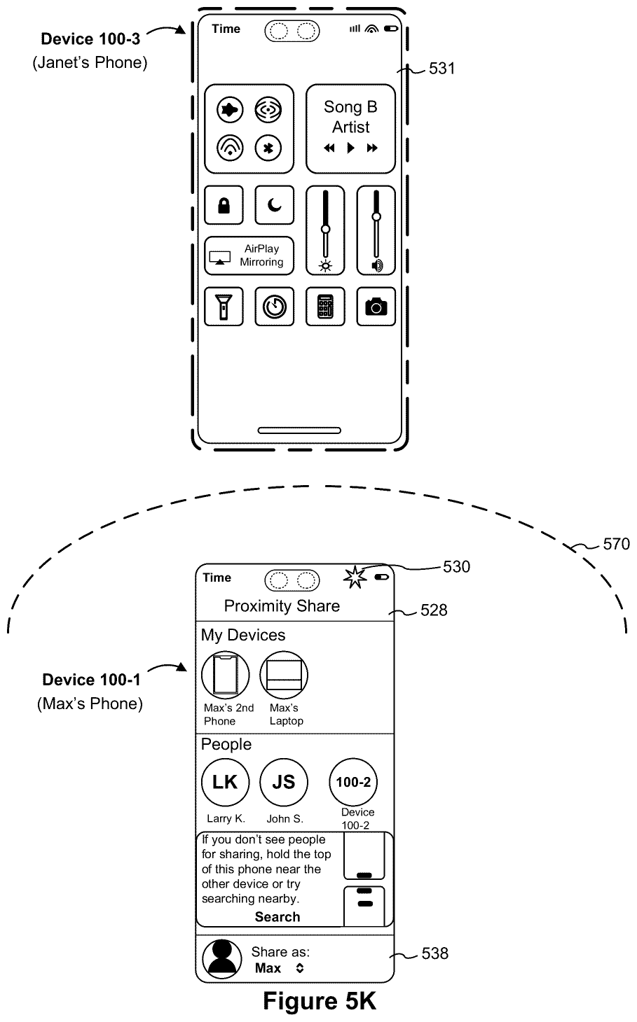

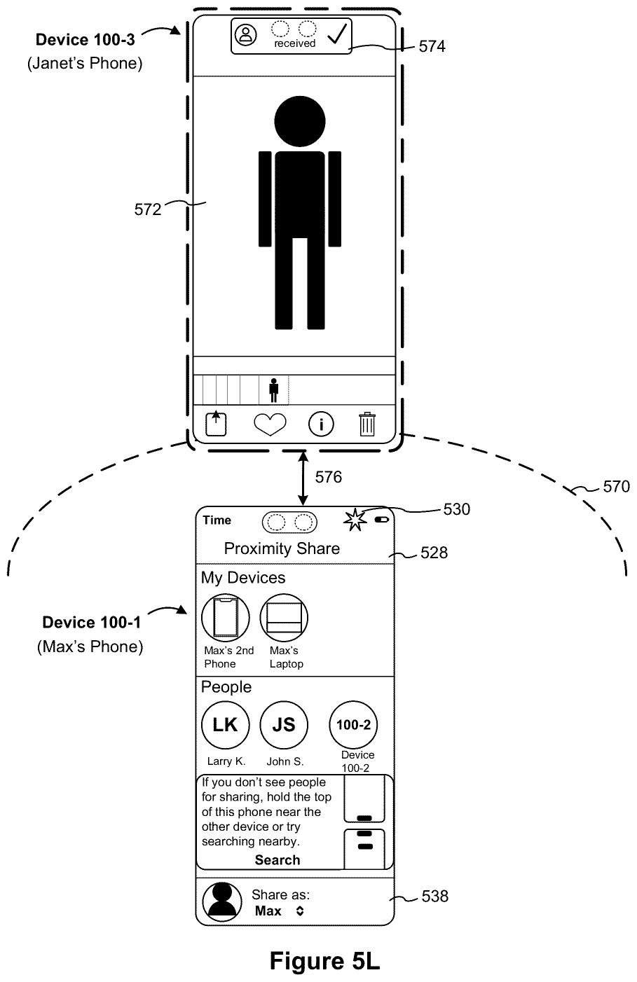

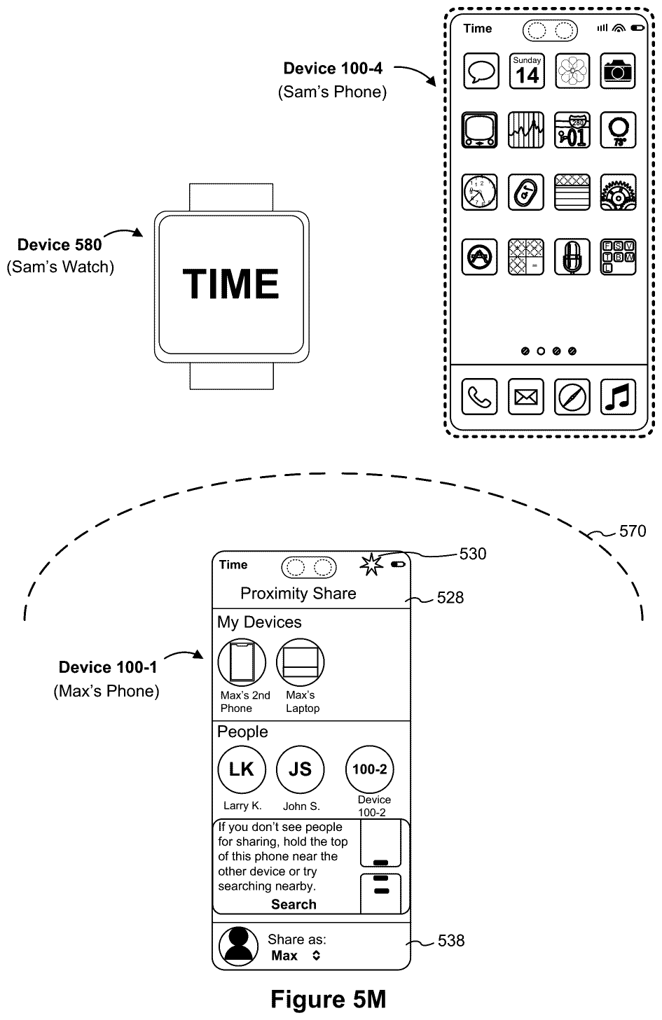

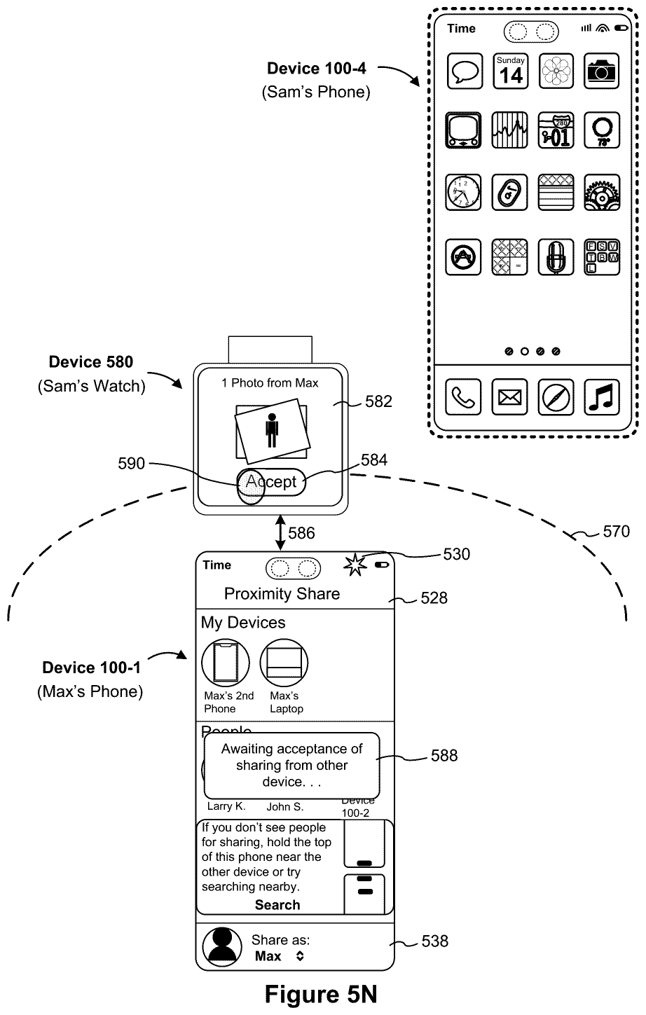

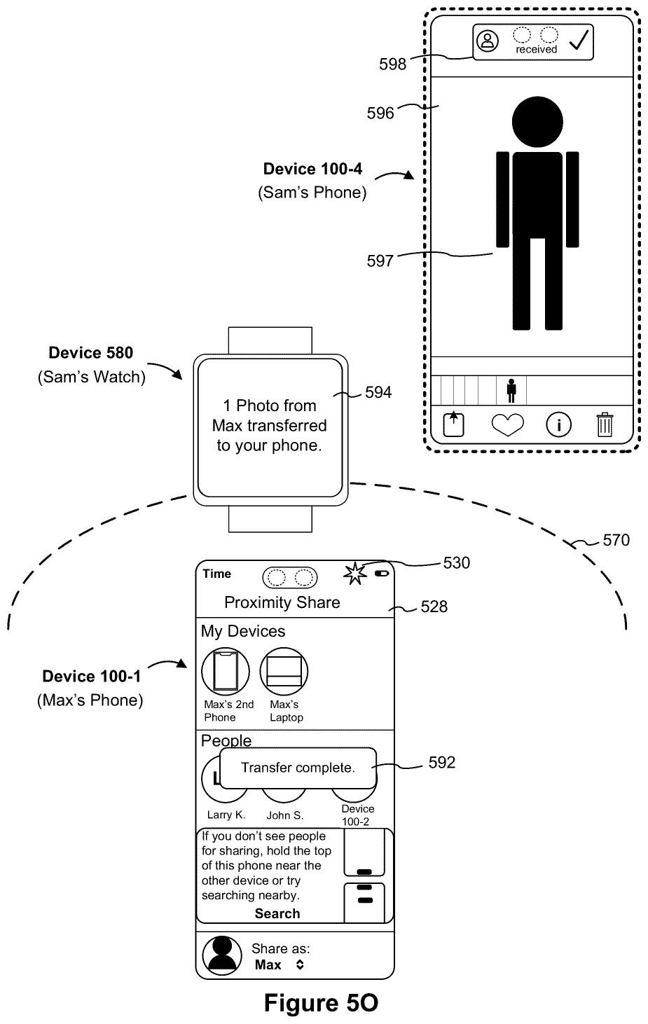

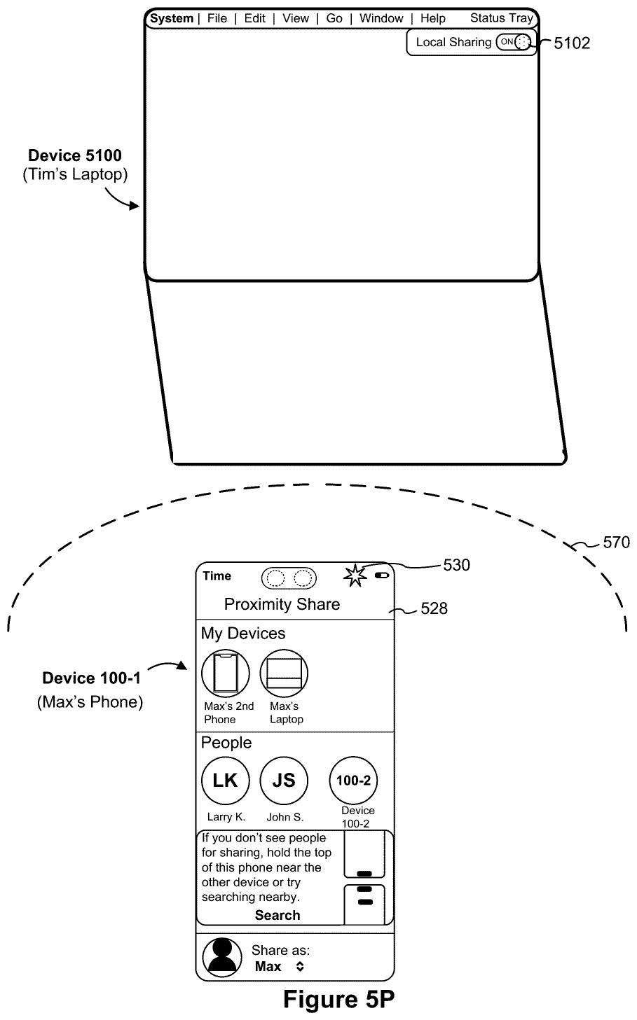

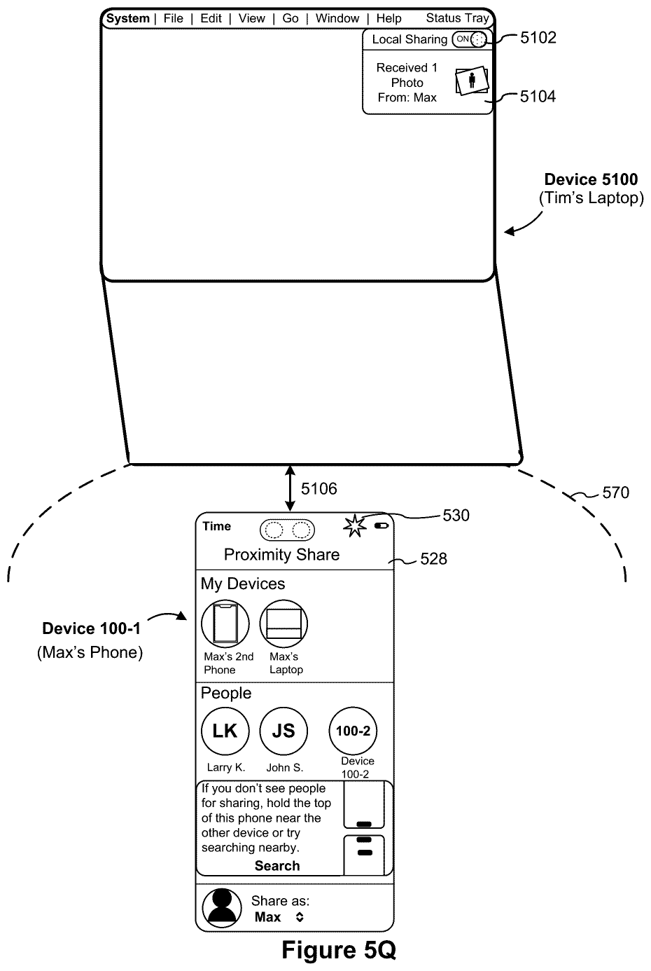

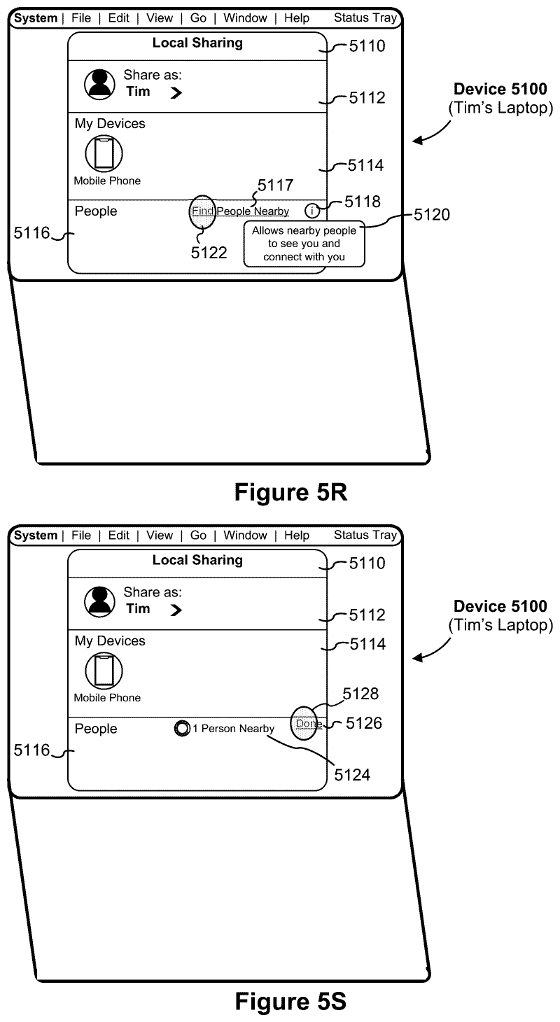

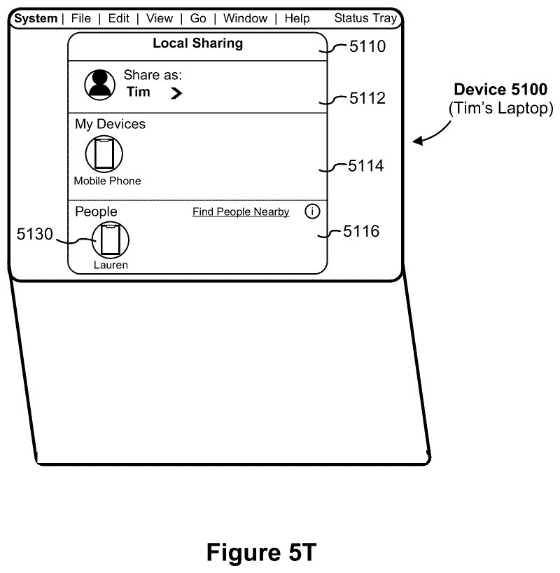

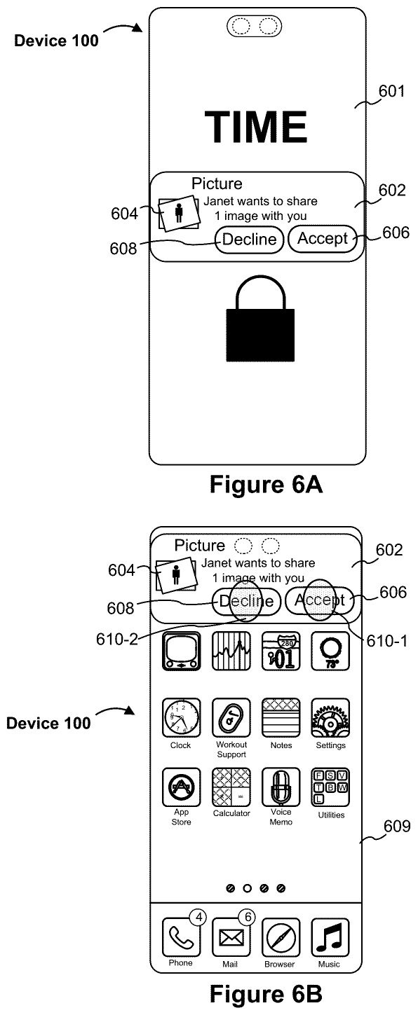

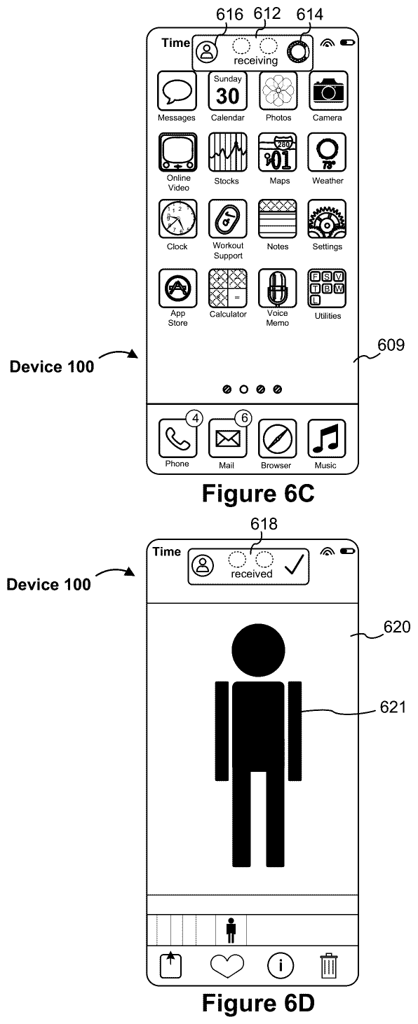

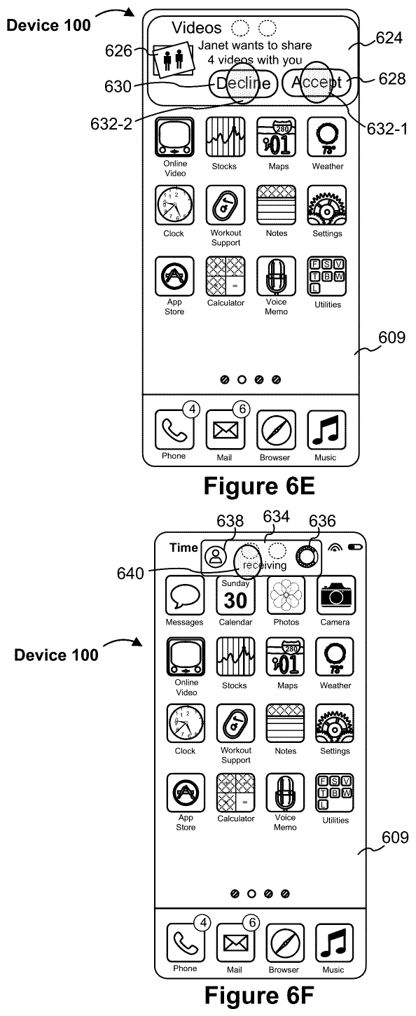

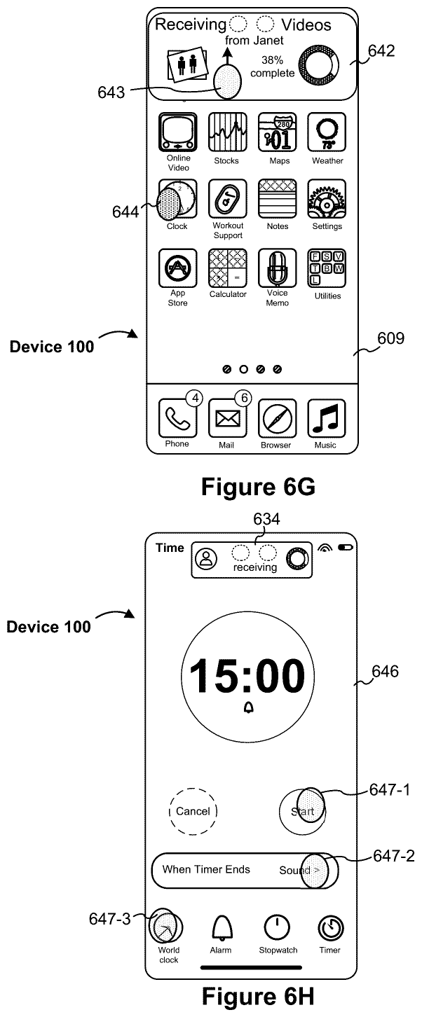

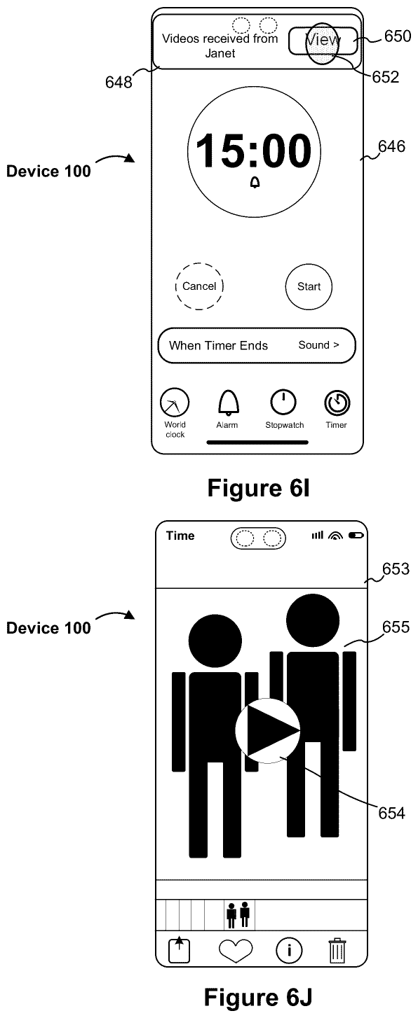

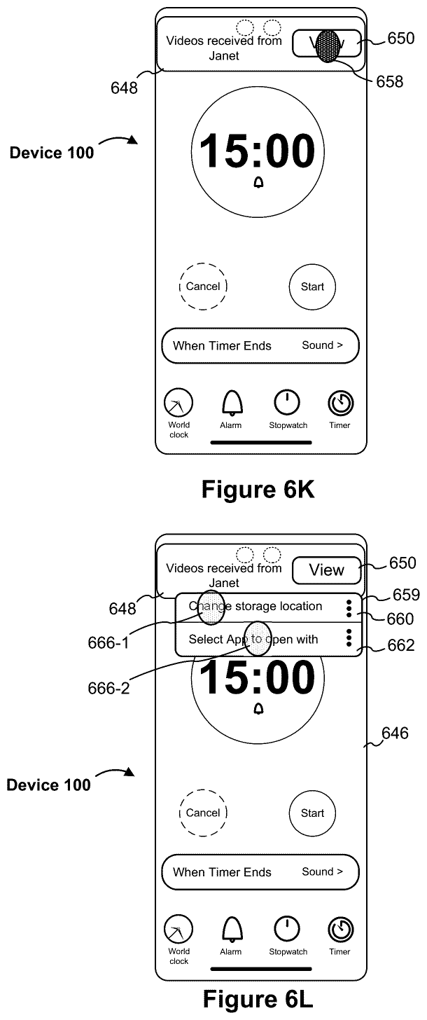

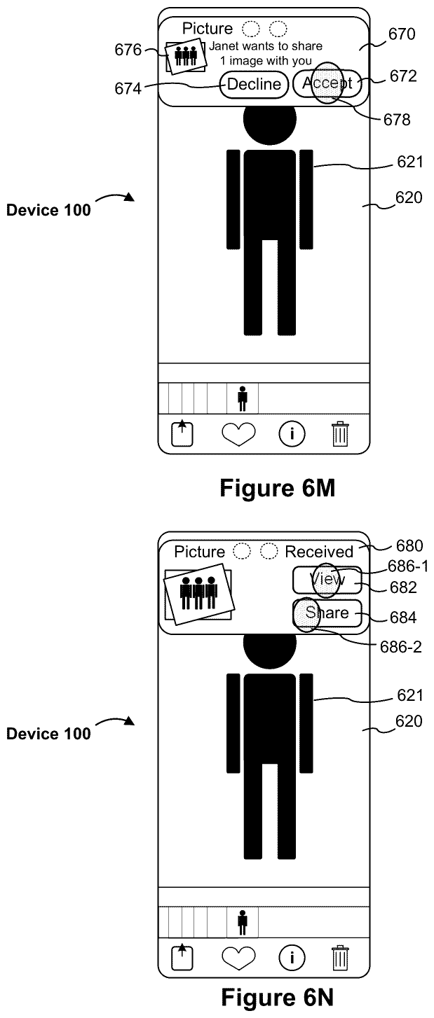

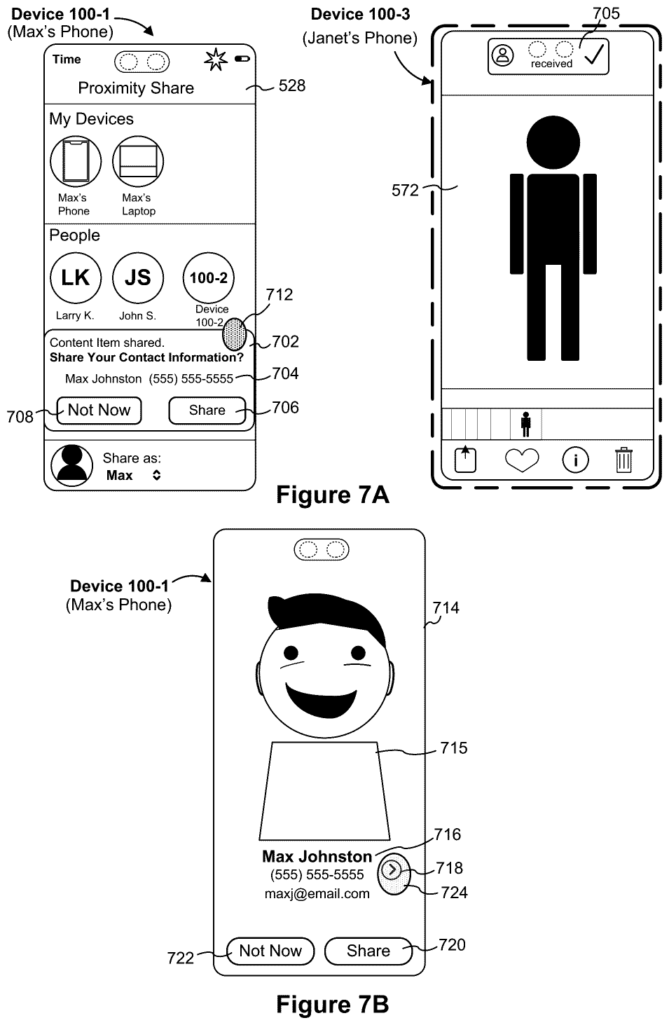

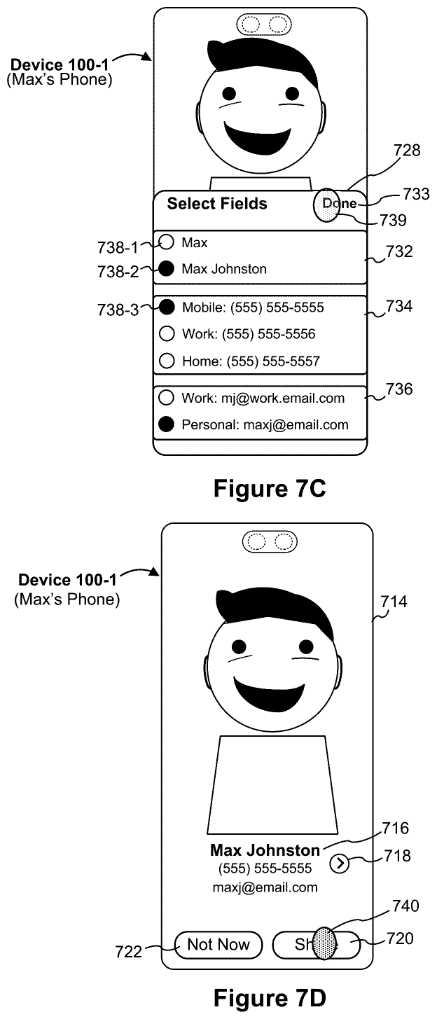

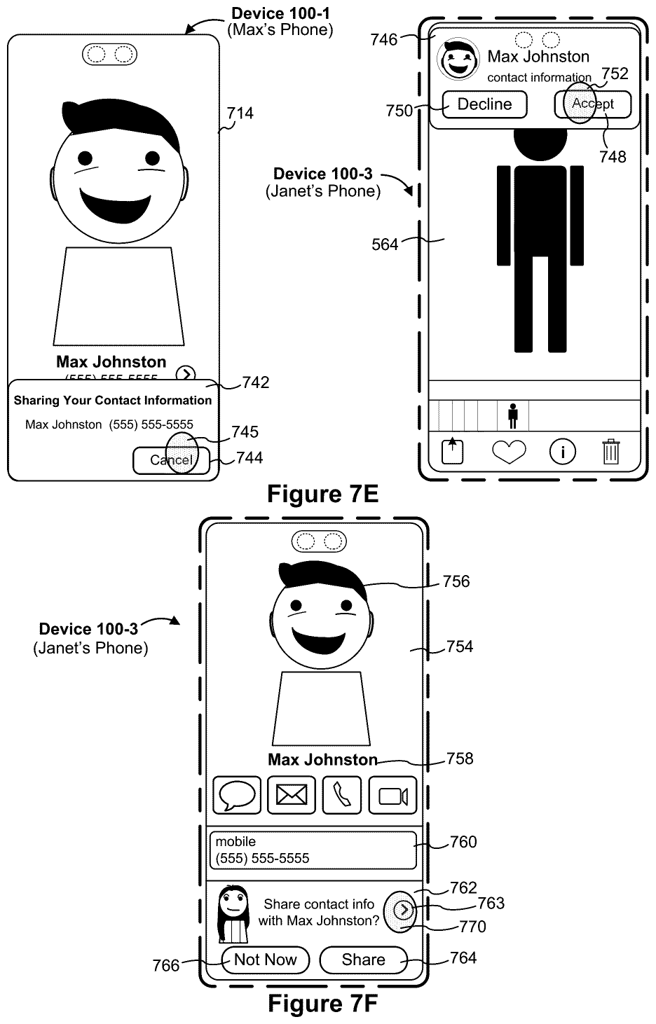

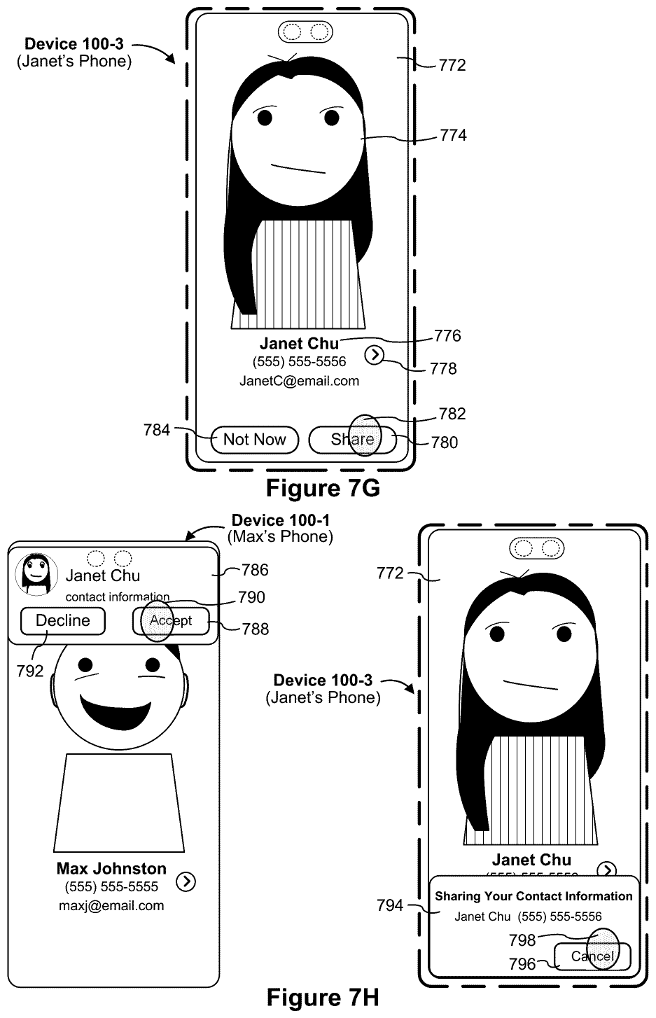

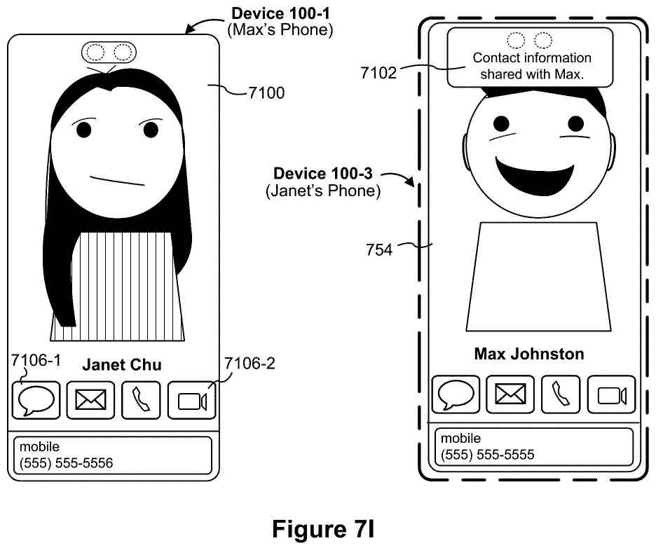

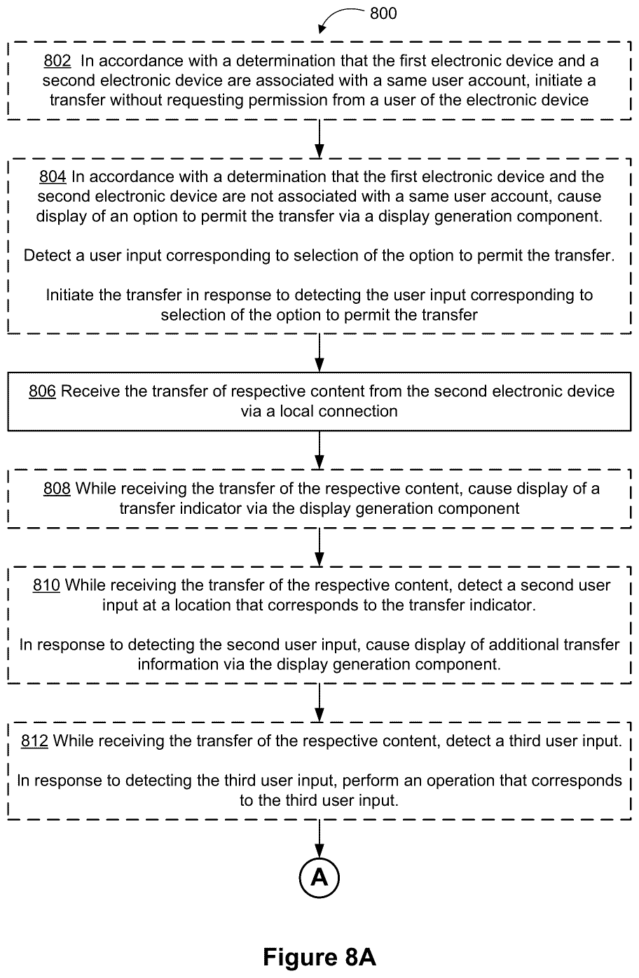

Below, FIGS. 1A-1B, 2, 3, and 4A-4B illustrate example devices. FIGS. 5A-5J illustrate example user interfaces and user interactions for broadcasting sharing availability and initiating local sharing of content in accordance with some embodiments. FIGS. 5K-5Q illustrate example user interfaces and user interactions for proximity-initiated sharing of content. FIGS. 5R-5T illustrate example user interfaces and user interactions for broadcasting sharing availability and initiating local sharing of content. FIGS. 6A-6N illustrate example user interfaces and user interactions for sharing content and viewing shared content. FIGS. 7A-7I illustrate example user interfaces and user interactions for sharing contact information.

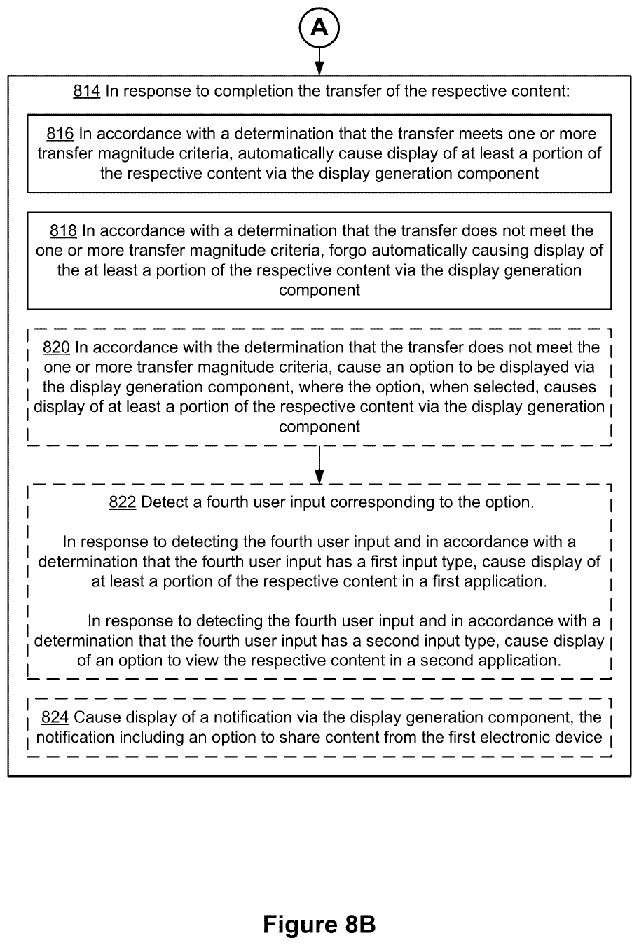

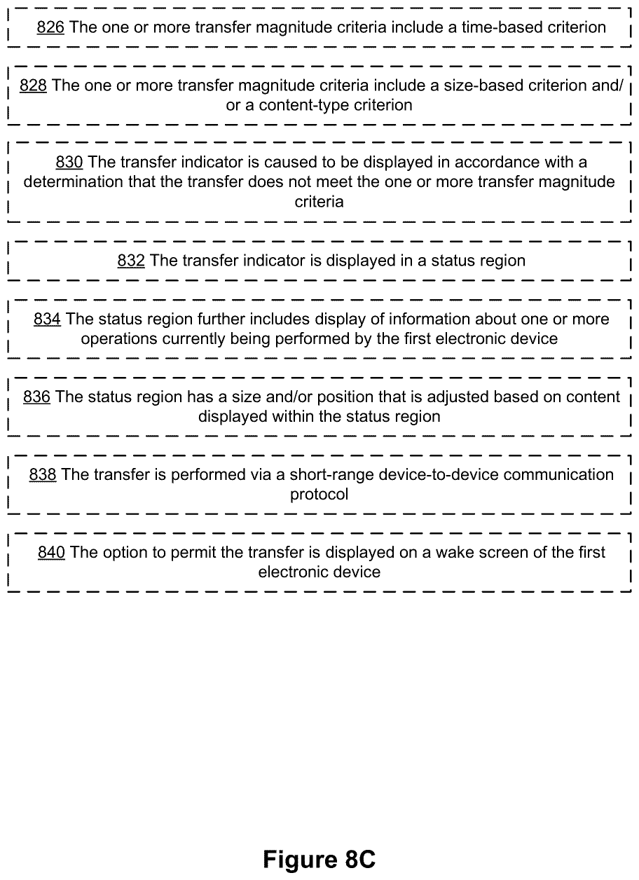

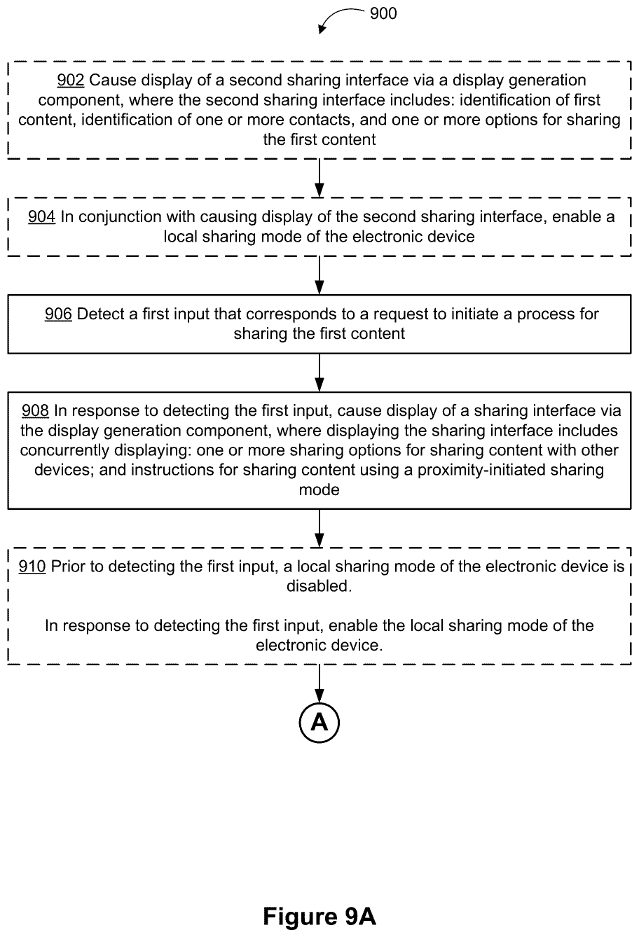

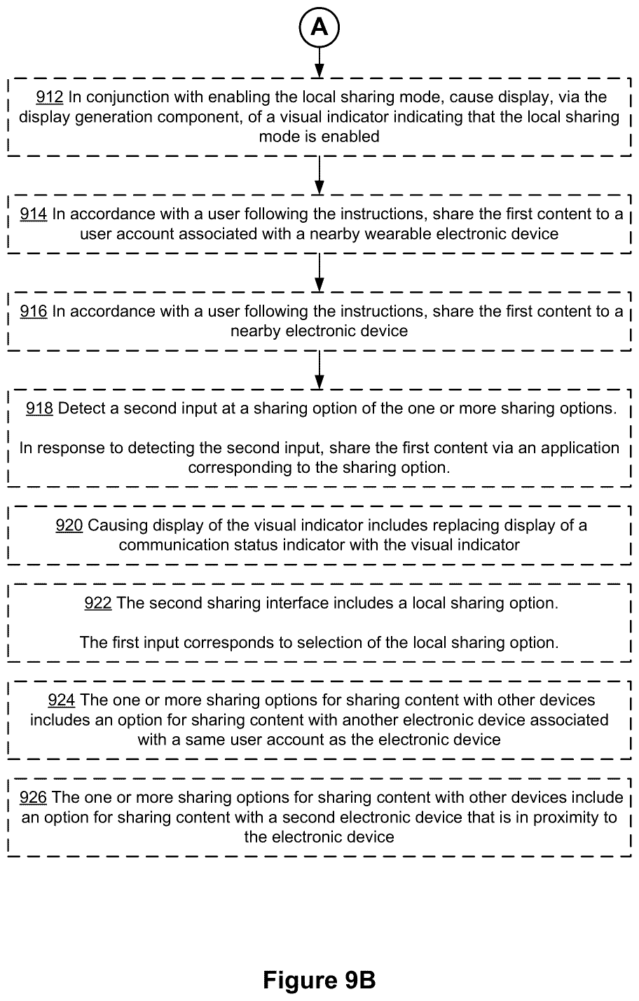

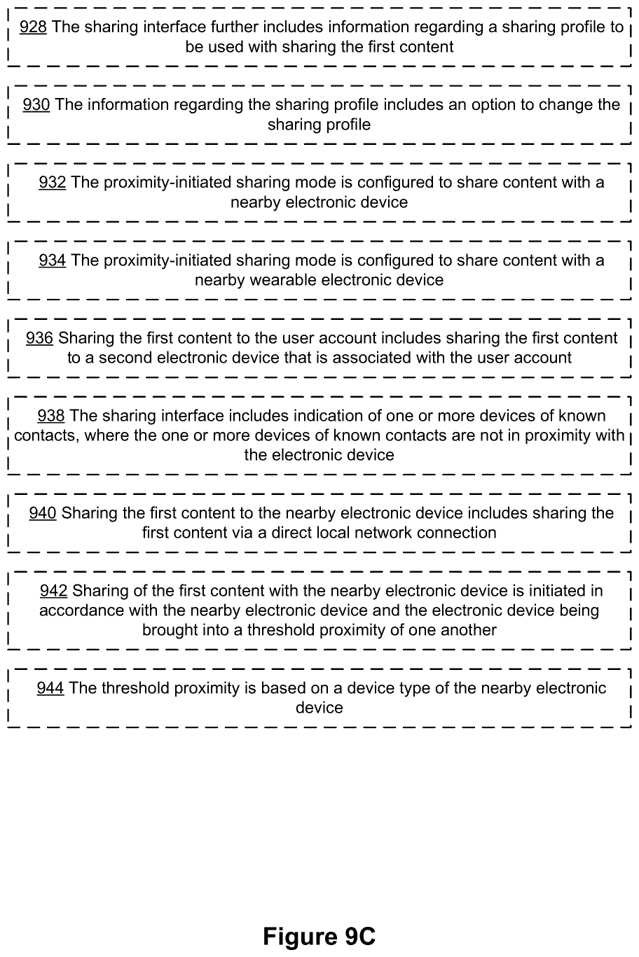

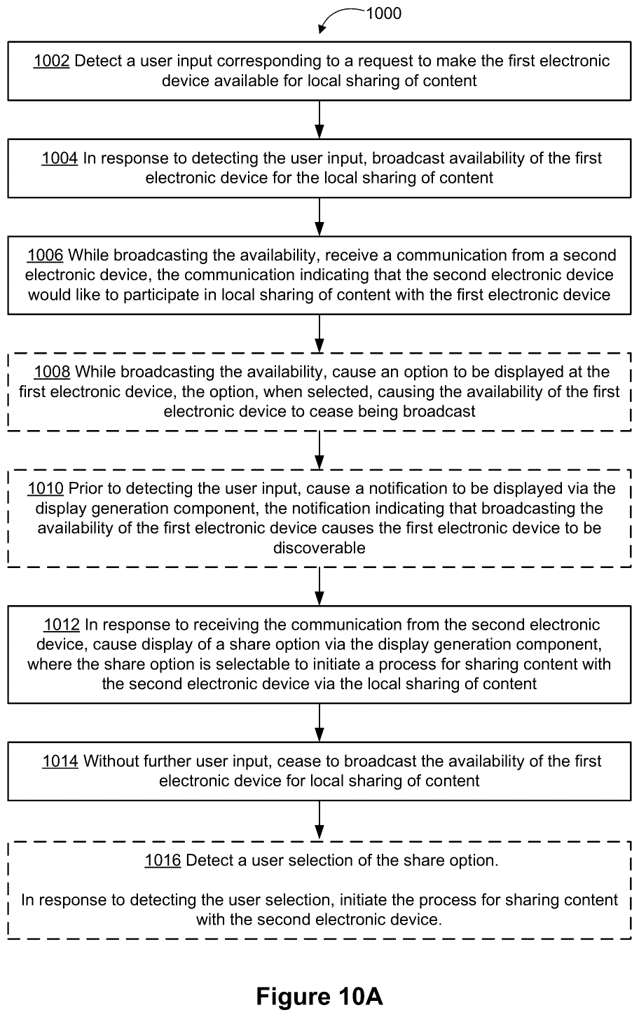

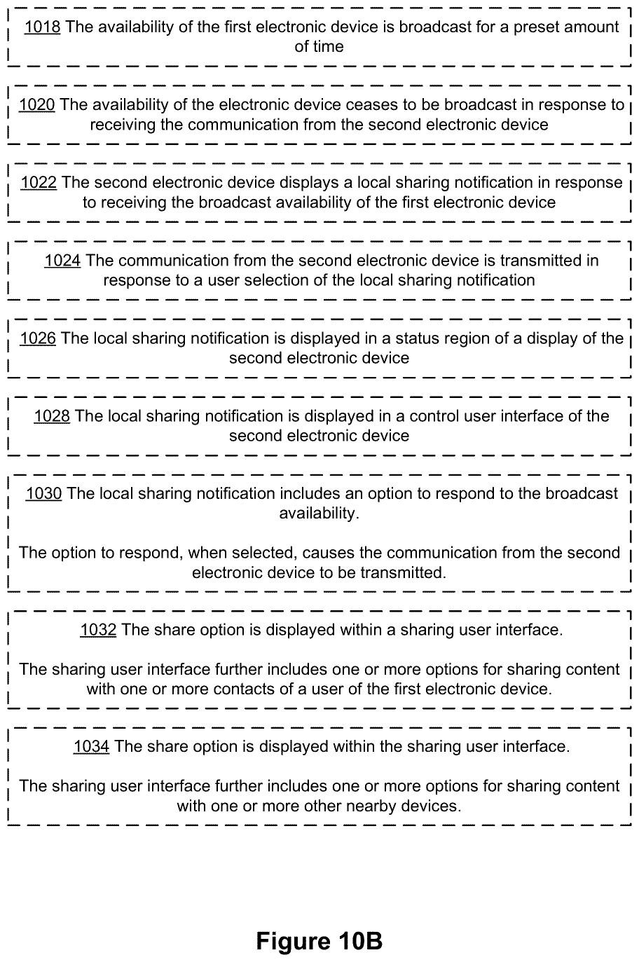

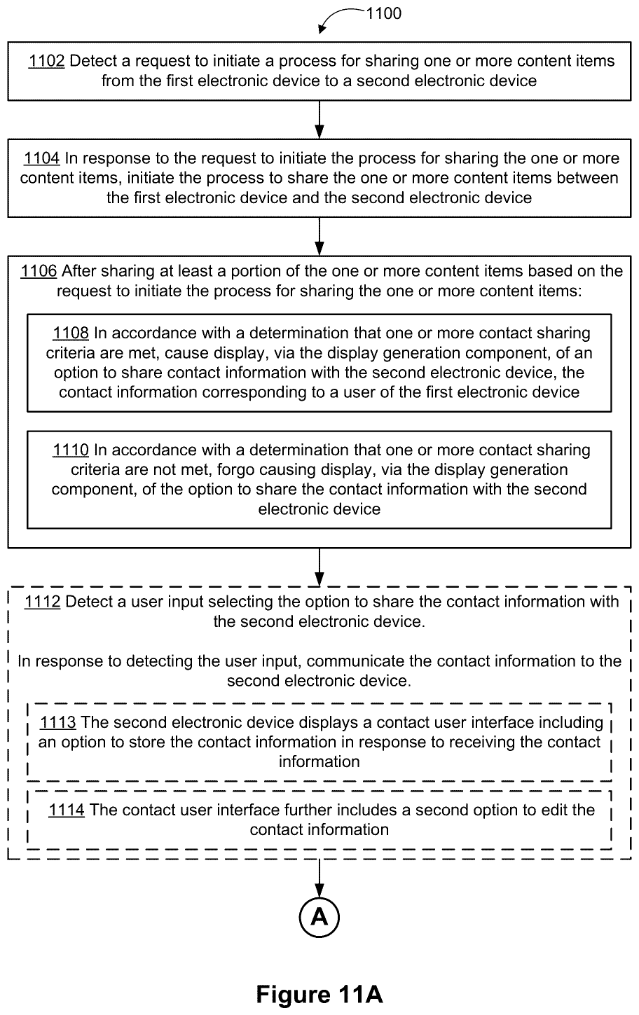

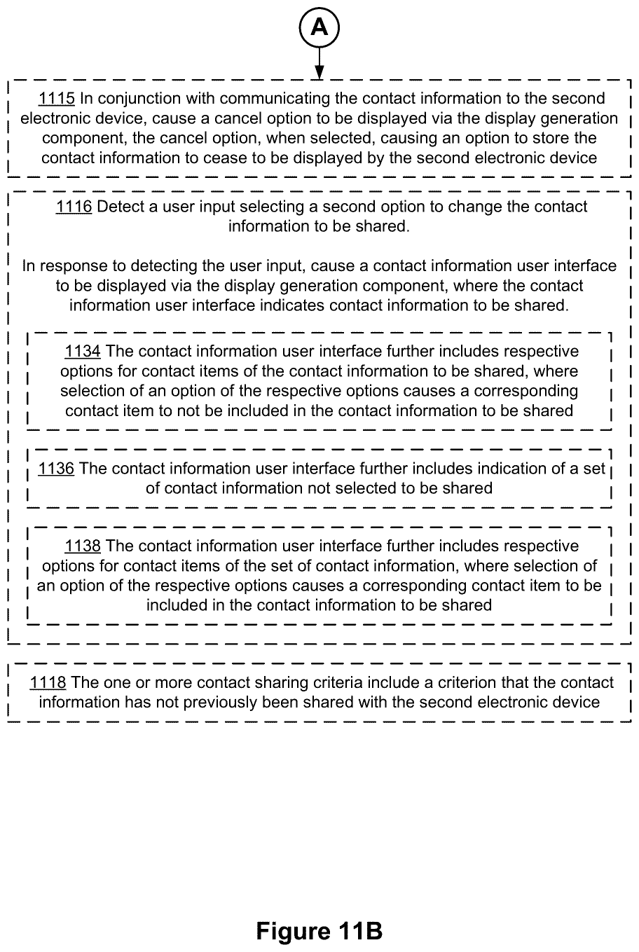

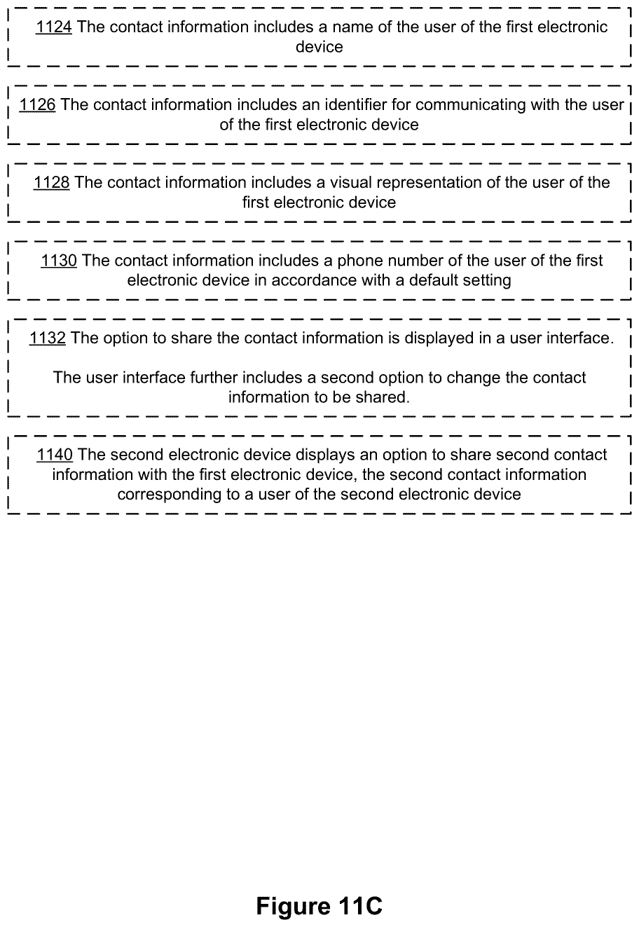

FIGS. 8A-8C are flow diagrams of a process for displaying shared content. FIGS. 9A-9C are flow diagrams of a process for proximity-initiated content sharing. FIGS. 10A-10B are flow diagrams of a process for broadcasting sharing availability. FIGS. 11A-11C are flow diagrams of a process for sharing contact information.

The user interfaces and device interactions in FIGS. 5A-5T, 6A-6N, and 7A-7I are used to illustrate the processes in FIGS. 8A-8C, 9A-9C, 10A-10B, and 11A-11C.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random-access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

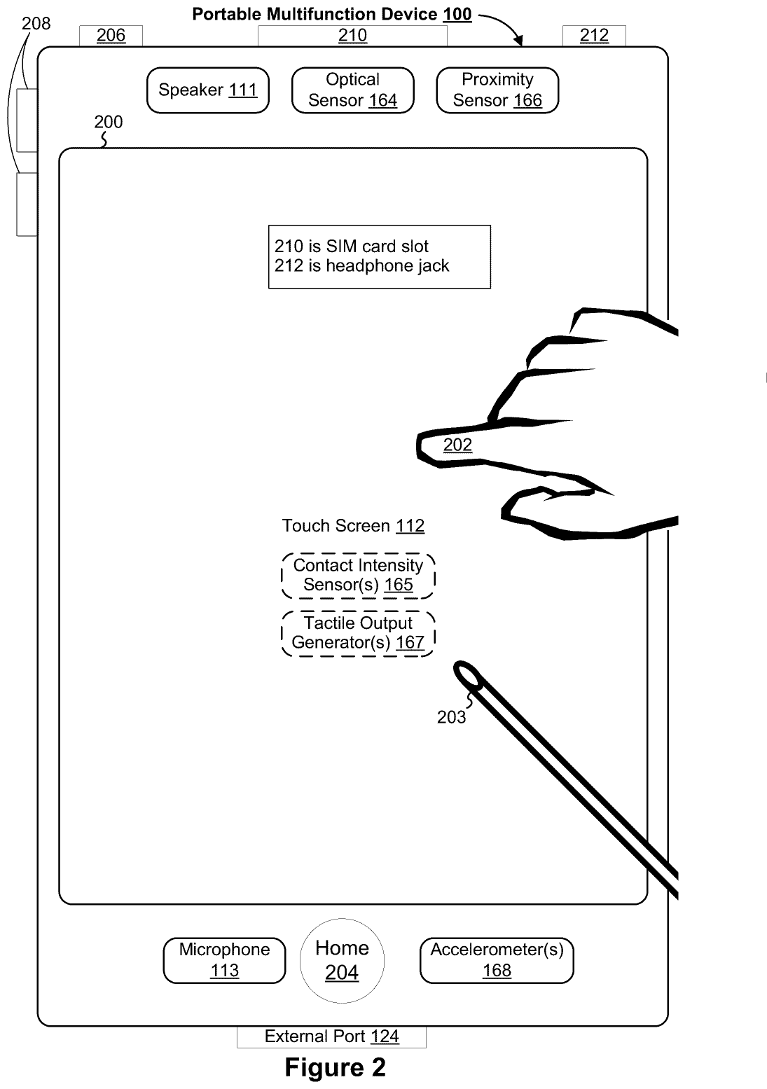

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

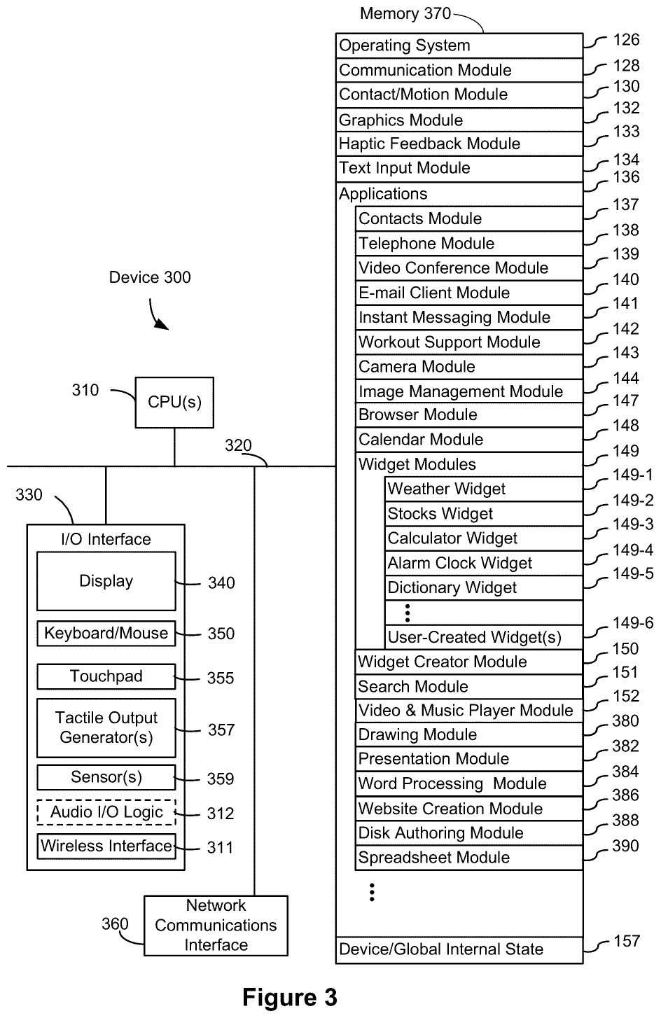

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture-which do not require that the intensity of the contact(s) meet a respective intensity threshold in order for the first gesture recognition criteria to be met—are in competition with second gesture recognition criteria for a second gesture-which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on touch-sensitive display system 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher-level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancelation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event-to-event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3 is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). In some embodiments, device 300 includes a wireless interface 311, e.g., for communication with one or more wearable audio output devices. In some embodiments, device 300 includes a network communications interface 360 for communication with remote devices (e.g., in conjunction with communication module 128).

Memory 370 includes high-speed random-access memory, such as DRAM, SRAM, DDR RAM or other random access solid-state memory devices; and optionally includes non-volatile memory, such as one or more magnetic disk storage devices, optical disk storage devices, flash memory devices, or other non-volatile solid-state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that are, optionally, implemented on portable multifunction device 100.

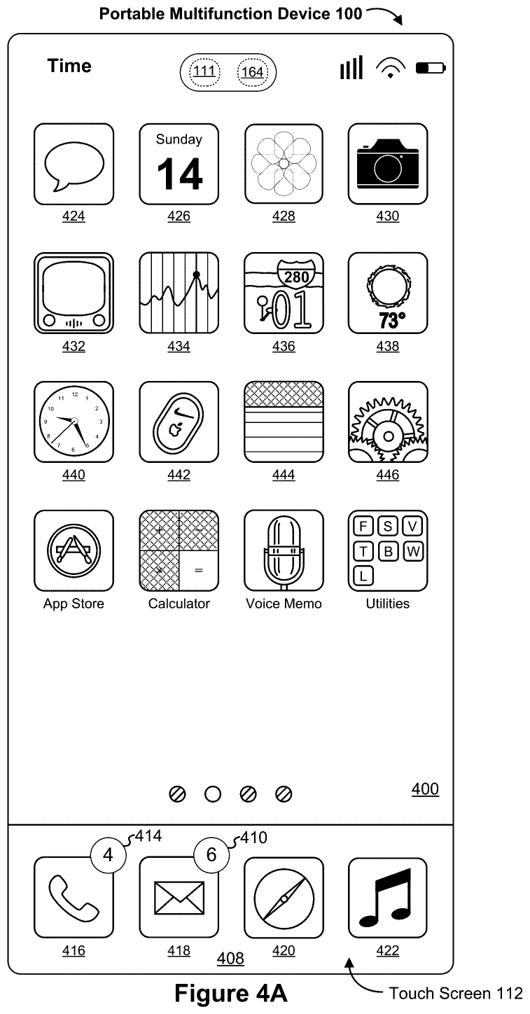

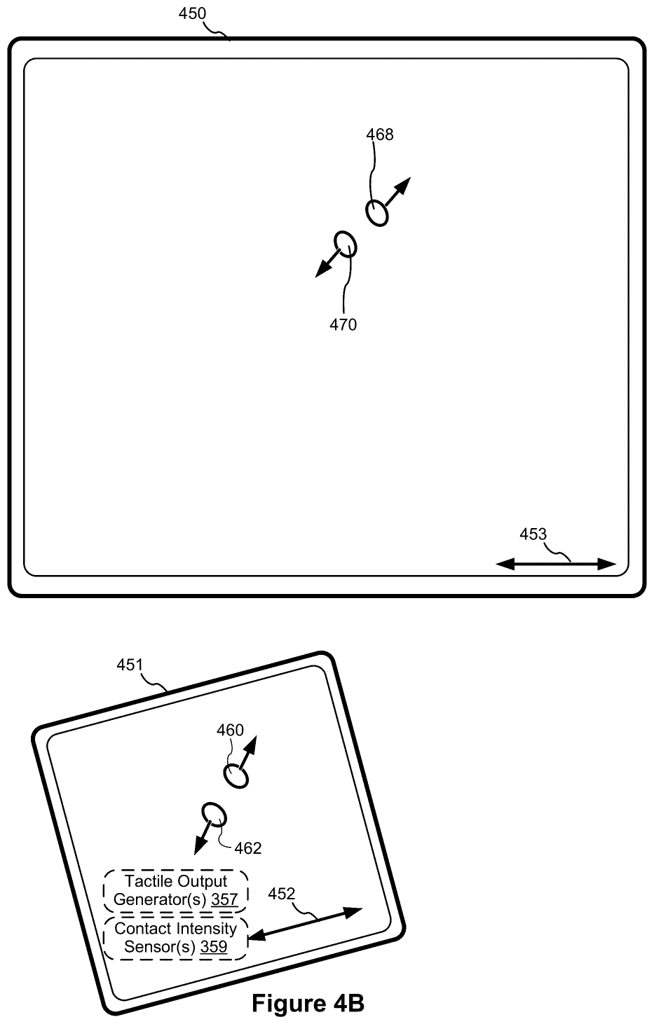

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3) with a touch-sensitive surface 451 (e.g., a tablet or touchpad 355, FIG. 3) that is separate from the display 450. Although many of the examples that follow will be given with reference to inputs on touch-sensitive display system 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse-based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms (milliseconds) in duration (e.g., 40, 100, or 120 ms, depending on the magnitude of the second intensity threshold, with the delay time increasing as the second intensity threshold increases). This delay time helps to avoid accidental recognition of deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

In some embodiments, one or more of the input intensity thresholds and/or the corresponding outputs vary based on one or more factors, such as user settings, contact motion, input timing, application running, rate at which the intensity is applied, number of concurrent inputs, user history, environmental factors (e.g., ambient noise), focus selector position, and the like. Example factors are described in U.S. patent application Ser. Nos. 14/399,606 and 14/624,296, which are incorporated by reference herein in their entireties.

### User Interfaces and Associated Processes

Attention is now directed towards embodiments of user interfaces (“UI”) and associated processes that may be implemented on an electronic device, such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5T, 6A-6N, and 7A-7I illustrate example user interfaces and user interactions in accordance with some embodiments. The user interfaces in these figures are used to illustrate the processes described below, including the processes in FIGS. 8A-8C, 9A-9C, 10A-10B, and 11A-11C.

For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector. Additionally, analogous operations are, optionally, performed on a device in communication with a display generation component (e.g., a wireless display device) that is separate from the device.

FIGS. 5A-5J illustrate example user interfaces and user interactions for broadcasting sharing availability and initiating local sharing of content in accordance with some embodiments. Devices 100-1 and 100-2 in FIGS. 5A-5J are examples with a particular form factor (e.g., corresponding to a smartphone). In some embodiments, the user interactions and user interfaces in FIGS. 5A-5J involve other types of devices, such as device 580 in FIG. 5M (e.g., corresponding to a smartwatch), device 5100 in FIG. 5P (e.g., corresponding to a laptop), and/or other types of devices. FIG. 5A shows device 100-1 denoted as “Max's Phone” displaying user interface 502 (e.g., that corresponds to a media viewing application). User interface 502 includes photo 504 and share option 506. In some embodiments, user interface 502 is displayed in response to a user selecting a media viewing icon or image management icon (e.g., on a home screen of device 100-1 and/or other screen). In some embodiments, user interface 502 is displayed in response to the user of device 100-1 taking a picture with device 100-1. In some embodiments, user interface 502 is displayed in response to user selecting an element corresponding to photo 504 (e.g., selecting a thumbnail or link for photo 504). FIG. 5A also shows user input 508 on share option 506.

FIG. 5A further shows a session region 501 that includes one or more sensors (e.g., speaker 111 and/or one or more optical sensors 164). In some embodiments, the one or more sensors are positioned within one or more cutouts (also called sensor regions) in a display of the device 100. In some embodiments, the session region 501 encompasses the one or more sensor cutouts for the one or more sensors. In some embodiments, additional sensors are located within the session region 501, where the cutouts illustrated in FIG. 5A include one or more sensors in the cutout (e.g., one or more additional sensors are positioned in the same cutout as speaker 111, and/or one or more additional sensors are positioned in the same cutout as optical sensor(s) 164, such as a structured light emitter and/or projector). It will be understood that in some embodiments, alternative shapes and/or numbers of cutouts (e.g., more than two or fewer than two), as well as numbers of sensors in a respective cutout, are implemented. In some embodiments, the cutouts are not visible from the surface of device 100. In some embodiments, the device displays an outline of the session region 502-1. For example, the device displays a dark color (e.g., black) inside and/or a dark outline around a periphery of the session region 501 that encompasses the cutouts for speaker 111 and optional sensors 164. In some embodiments, the device displays the session region 501 (e.g., the interior of session region 501) with a color that matches, or otherwise blends with, a color of the sensors that are positioned within the cutouts.

FIG. 5B shows a transition from FIG. 5A in response to detecting user input 508. Device 100-1 in FIG. 5B displays sharing user interface 510 that includes dismiss option 512, photo 504, contacts section 516, and sharing section 522. In some embodiments, dismiss option 512, when selected, causes user interface 510 to cease to be displayed. For example, user interface 510 is replaced with user interface 502 in response to selection of dismiss option 512. FIG. 5B further shows connectivity indicator 514 (e.g., indicating that device 100-1 is communicatively coupled to a wireless network, cellular network, and/or other type of network). In the example of FIG. 5B, photo 504 is selected for sharing, as indicated by selection indicator 527. In some embodiments, user inputs at selection indicator 527 toggle selection of the corresponding photo (e.g., selected for inclusion in a subsequent sharing operation). Contacts section 516 includes selectable icons 518 for contacts of the user of device 100-1. Each selectable icon 518 includes a respective sharing indicator 520 that indicates an application and/or protocol to be used to share content with the respective contact. For example, selectable icon 518-1, when selected, initiates a process to share photo 504 with contact “T. Yorke” via a messaging application, as indicated by sharing indicator 520-1. As another example, selectable icon 518-2, when selected, initiates a process to share photo 504 with contact “L. Migh” via a wireless protocol, as indicated by sharing indicator 520-2. Sharing section 522 includes options 524 for sharing content via different applications and/or protocols. For example, option 524-1 corresponds to a messaging application (e.g., an instant messaging application), option 524-2 corresponds to a proximity-initiated sharing protocol, and option 524-3 corresponds to an electronic mail application. In some embodiments, sharing section 522 includes an email affordance for emailing the selected photos to a selected recipient, an SMS/MMS affordance for sending the selected photos via an instant message to the selected recipient, and/or a third-party app affordance for sharing the selected photos with the selected recipient via a third-party application.

FIG. 5B further shows user input 526-1 selecting option 524-1, user input 526-2 selecting option 524-2, user input 526-3 selecting option 524-3, user input 526-4 selecting option 518-2, and user input 526-5 selecting a selection indicator of photo 505. User input 526-1 initiates a process to share photo 504 via the messaging application (e.g., causes display of a user interface corresponding to the messaging application). User input 526-2 causes display of a proximity sharing interface (e.g., for proximity-initiated sharing). User input 526-3 initiates a process to share photo 504 via the electronic mail application (e.g., causes display of a user interface corresponding to the electronic mail application). User input 526-4 initiates a process to share photo 504 with contact “L. Migh”. User input 526-5 causes selection of photo 505 (e.g., to be included in a subsequent sharing operation).

FIG. 5C shows a transition from FIG. 5B in response to detecting user input 526-2. Device 100-1 in FIG. 5C displays user interface 528 that includes devices section 532, people section 534, instructions section 536, and identifying section 538. FIG. 5C further shows proximity indicator 530 that indicates a sharing mode is enabled for device 100-1. In some embodiments, the sharing mode includes enabling one or more wireless protocols (e.g., Bluetooth, Wi-Fi, and/or NFC protocols). In accordance with some embodiments, display of proximity indicator 530 replaces display of connectivity indicator 514 from FIG. 5B. In some embodiments, proximity indicator 530 is displayed concurrently with connectivity indicator 514.

Devices section 532 includes icons for devices associated with the same user account as device 100-1, labeled “Max's 2^{nd} Phone” and “Max's Laptop”. In some embodiments, devices section 532 includes devices that are available for local sharing of content. In some embodiments, local sharing of content includes sharing of content via a direct connection (e.g., via Bluetooth, Wi-Fi, and/or NFC protocol). In some embodiments, local sharing of content includes sharing content via a same wireless network. In some embodiments, one or more devices associated with the same user account are displayed in devices section 532 even if not in proximity with device 100-1. For example, a device associated with the same user account is displayed even if the device is not connected to the same wireless network and not directly connected to device 100-1 (e.g., via a peer-to-peer wireless connection). In some embodiments, devices section 532 includes devices associated with one or more user accounts that have an association with the user account of device 100-1 (e.g., guest devices, temporary devices, and/or devices with other associations).

People section 534 includes icons for contacts of device 100-1, labeled “Larry K.” and “John S.”. In some embodiments people section 534 includes icons for contacts that are available for local sharing of content (e.g., via a peer-to-peer connection and/or via proximity-initiated sharing). In some embodiments, one or more contacts are displayed in people section 534 even if not in proximity with device 100-1. For example, a contact is displayed in people section 534 even if a device of the contact is not connected to the same wireless network and not directly connected to device 100-1 (e.g., via a peer-to-peer wireless connection). In some embodiments, people section 534 includes icons for one or more contacts of device 100-1 and/or icons for one or more devices available for local sharing of content with device 100-1.

In accordance with some embodiments, instructions section 536 includes text instructions and/or pictorial instructions for using proximity-initiated sharing. In some embodiments, the proximity-initiated sharing is initiated via an NFC protocol. In some embodiments, the proximity-initiated sharing includes sharing of content via a direct connection (e.g., via Bluetooth, Wi-Fi, and/or NFC protocol). In some embodiments, the proximity-initiated sharing includes sharing content via a wireless network. For example, the sharing process is initiated via NFC protocol and includes transferring content via a Wi-Fi and/or cellular network. Instructions section 536 also includes search option 542 to search for nearby devices.

Identifying section 538 includes information about how device 100-1 is identified while broadcasting its share capabilities and/or engaging in content sharing with a remote device. In the example of FIG. 5C, identifying section 538 includes icon 539 that indicates an image/avatar to be displayed during a subsequent broadcasting and/or sharing process and name 541 to be displayed during a subsequent broadcasting and/or sharing process. Identifying section 538 also includes selectable option 540 to change and/or switch the identifying information (e.g., icon 539 and/or name 541).

FIG. 5C further shows user input 544-1 selecting search option 542, user input 544-2 selecting contact icon 535, and user input 544-3 selecting device icon 533. User input 544-1 initiates a process to search for nearby devices (e.g., devices within a communicative coupling range). User input 544-2 initiates a process to share photo 504 with the contact corresponding to contact icon 535 (e.g., prompting the user to select a sharing protocol for sharing with the contact and/or sending a share request to a device of the contact). User input 544-3 initiates a process to share photo 504 with the device corresponding to device icon 533 (e.g., prompting the user to select a sharing protocol for sharing with the device or automatically sharing photo 504 via a local connection).

FIG. 5D shows a transition from FIG. 5C in response to detecting user input 544-1. User interface 528 in FIG. 5D includes searching section 546, e.g., replacing instructions section 536. Searching section 546 includes a notification that device 100-1 is visible to other nearby devices while the search is active (e.g., device 100-1 is broadcasting its sharing capabilities) and cancel option 548. In some embodiments, cancel option 548, when selected, causes device 100-1 to stop searching for nearby devices.

FIG. 5E shows device 100-2 denoted as “John's Phone” displaying notification 550 (sometimes herein called a local sharing notification) in response to detecting that device 100-1 is searching for nearby devices, as shown in FIG. 5D. In the example of FIG. 5E, notification 550 is displayed over (e.g., overlaid with) a home screen of device 100-2. In some embodiments, notification 550 is overlaid with another screen (e.g., a wake screen or other type of screen) or application-specific interface (e.g., a user interface for a telephony application, a productivity application, and/or other type of application), or may be displayed in a control user interface (e.g., control user interface 531, FIG. 5K) of device 100-2. In some embodiments, notification 550 is an updated session region 501 (e.g., an expanded session region). In some embodiments, the expanded session region includes information about the incoming share notification and/or one or more controls for interacting with the incoming share notification. In some embodiments, session region 501 adjusts size and/or position based on active functions, applications, incoming notifications, and/or other factors. Notification 550 includes information about the sharing availability of device 100-1 including name 541. In some embodiments, notification 550 includes an image/avatar corresponding to icon 539. Notification 550 also includes accept option 552 and decline option 554. FIG. 5E further shows user input 556-1 selecting accept option 552 and user input 556-2 selecting decline option 554. User input 556-1 causes device 100-2 to become visible to device 100-1 for content sharing. In some embodiments, selecting accept option 552 enables a sharing mode for device 100-2 (e.g., enables one or more wireless protocols). User input 556-2 declines the invitation to become visible for sharing such that device 100-2 does not become visible.

FIG. 5F shows device 100-1 displaying user interface 528 in accordance with user input 556-1. User interface 528 in FIG. 5F includes icon 558 corresponding to device 100-2 in response to user input 556-1 causing device 100-2 to become visible to device 100-1 for sharing. In accordance with some embodiments, device 100-1 ceases to search (e.g., ceases to broadcast its sharing capabilities) in response to device 100-2 becoming visible (e.g., in user interface 528 of device 100-1). Icon 558, when selected, initiates a process to share photo 504 with device 100-2 (e.g., sends a request to share photo 504 to device 100-2). User interface 528 in FIG. 5F includes instructions section 536, e.g., replacing searching section 546 from FIG. 5D. For example, ceasing to display searching section 546 indicates to the user of device 100-1 that the device is no longer searching, e.g., no longer broadcasting its sharing capabilities to nearby devices. FIG. 5F further shows user input 560 at search option 542.

FIG. 5G shows a transition from FIG. 5F in response to detecting user input 560, corresponding to a first time. User interface 528 in FIG. 5G includes icon 558 and searching section 546, e.g., replacing instructions section 536. In some embodiments, the search in FIG. 5G does not cause a notification at device 100-2 (e.g., due to device 100-2 having previously responded in FIG. 5E and being included in people section 534). In some embodiments, the search in FIG. 5G does not cause a notification at a nearby device that responded to a notification from the previous search in FIG. 5D (e.g., in accordance with less than a predetermined amount of time having elapsed since the previous search).

FIG. 5H shows device 100-1 at a second time, subsequent to the first time shown in FIG. 5G. In the example of FIG. 5H no nearby devices responded to the search shown in FIG. 5G and therefore notification 562 is displayed. In some embodiments, notification 562 is displayed in accordance with no nearby devices responding to the search in FIG. 5G within a predetermined time period (e.g., 10 seconds, 20 seconds, 30 seconds, or 1 minute). FIG. 5H also shows user interface 528 including instructions section 536, e.g., replacing searching section 546 from FIG. 5G. In accordance with some embodiments, device 100-1 in FIG. 5H is no longer searching and therefore has reduced its visibility to nearby devices.

FIG. 5I illustrates device 100-1 displaying user interface 528 and user input 564 at selectable option 540. FIG. 5J illustrates a transition from FIG. 5I in response to detecting user input 564. Device 100-1 in FIG. 5J displays user interface 566 (e.g., overlaid over a portion of user interface 528). User interface 566 includes options 567 for identifying information to be used with subsequent sharing and/or broadcasting operations. Options 567 include option 567-1 corresponding to a profile with name “Max Johnston” and a corresponding icon, option 567-2 corresponding to a profile with name “Max” with a default silhouette icon (e.g., no personalized icon), and option 567-3 corresponding to anonymous profile (e.g., including no identifying information about the user). In some embodiments, user input 564 at selectable option 540 causes display of a user interface that enables the user to select which identifying information is to be included. FIG. 5J further shows user input 568 selecting option 567-2.

FIGS. 5K-5Q illustrate example user interfaces and user interactions for proximity-initiated sharing of content in accordance with some embodiments. FIG. 5K illustrates a transition from FIG. 5J in response to user input 568. In the example of FIG. 5K, identifying section 538 includes the name “Max,” corresponding to option 540. FIG. 5K further shows device 100-3, denoted “Janet's Phone,” outside of proximity-initiated sharing range 570. For example, proximity-initiated sharing range 570 may correspond to a near-field communication (NFC) range. In the example of FIG. 5K, device 100-3 displays control user interface 531.

FIG. 5L shows device 100-3 within proximity-initiated sharing range 570 and a corresponding proximity-initiated sharing of content. In the example of FIG. 5L, photo 504 is transferred from device 100-1 to device 100-3 (e.g., via a direct wireless connection) in response to device 100-3 being within proximity-initiated sharing range 570. As a result of the transfer of content, device 100-3 in FIG. 5L displays a user interface (e.g., corresponding to an image management application) that includes photo 572, which corresponds to photo 504 at device 100-1. In some embodiments, photo 572 is displayed automatically in response to the transfer of content. In some embodiments, photo 572 is displayed in response to a user input at device 100-3 (e.g., a user selection of an option to view the transferred content). Device 100-3 in FIG. 5L also displays notification 574 indicating that the transfer of photo 504 from device 100-1 is completed. In some embodiments, notification 574 is an updated session region 501 (e.g., an expanded session region). FIG. 5L also shows device 100-3 at distance 576 from device 100-3. In some embodiments, distance 576 corresponds to (e.g., is equal to or less than) a trigger distance for proximity-initiated sharing. In some embodiments, after device 100-3 is moved to distance 576 the transfer continues even if device 100-3 moves beyond distance 576. In some embodiments, distance 576 is based on a device type of device 100-3 and/or device 100-1. In some embodiments, distance 576 is based on capabilities of one or more sensors in device 100-3 and/or device 100-1. In some embodiments, the transfer of content in FIG. 5L is performed in accordance with device 100-1 and/or device 100-3 having a sharing mode enabled (e.g., as indicated by proximity indicator 530).

FIG. 5M illustrates device 580, denoted “Sam's Watch” and device 100-4, denoted “Sam's Phone”, each outside of proximity-initiated sharing range 570. In the example of FIG. 5M, device 580 and device 100-4 are associated with a same user account (e.g., Sam's user account). In FIG. 5M, device 580 is displaying a current time and device 100-4 is displaying a home screen. FIG. 5N shows device 580 within proximity-initiated sharing range 570 of device 100-1. FIG. 5N further shows user interface 582 displayed on device 580. User interface 582 includes an indication of the content to be shared (e.g., photo 504) from device 100-1 and accept option 584. In some embodiments, user interface 582 includes a decline option and/or a dismiss option. In the example of FIG. 5N, device 100-4 does not display a notification in response to device 580 being within proximity-initiated sharing range 570. In some embodiments, device 100-4 displays a notification with an accept option. For example, the user of device 580 and device 100-4 may accept the transfer at either device in some embodiments. Device 100-1 in FIG. 5N displays notification 588 indicating that the content share is dependent on acceptance from device 580 (and/or device 100-4). In some embodiments, notification 588 is displayed in an updated session region 501. FIG. 5N also shows user input 590 selecting accept option 584 in user interface 582 on device 580. FIG. 5N also shows device 580 at distance 586 from device 100-1. In some embodiments, distance 586 corresponds to a trigger distance for proximity-initiated sharing. In some embodiments, after device 580 is moved to distance 586 the transfer continues even if device 580 moves beyond distance 586 during the transfer. In some embodiments, distance 586 is based on a device type of device 580 and/or device 100-1. In some embodiments, distance 586 is based on capabilities of one or more sensors in device 580 and/or device 100-1. In some embodiments, the transfer of content in FIG. 5N is performed in accordance with device 100-1 and/or device 580 having a sharing mode enabled (e.g., as indicated by proximity indicator 530).

FIG. 5O illustrates a transition from FIG. 5N in response to user input 590. FIG. 5O shows device 580 displaying notification 594 indicating that the shared content has been received. In the example of FIG. 5O, the shared content (e.g., photo 504) is received at device 100-4. In some embodiments, the shared content is transferred to device 580 and/or device 100-4. Device 100-1 in FIG. 5O displays notification 592 indicating that the shared content transfer is complete. In some embodiments, notification 592 is displayed in an updated session region 501. As a result of the transfer of content, device 100-4 in FIG. 5O displays user interface 596 (e.g., corresponding to an image management application) that includes photo 597, which corresponds to photo 504 at device 100-1. In some embodiments, user interface 596 with photo 597 is displayed automatically in response to the transfer of content. In some embodiments, user interface 596 with photo 597 is displayed in response to a user input at device 100-4 (e.g., a user selection of an option to view the transferred content). Device 100-4 in FIG. 5O also displays notification 598 indicating that the transfer of photo 504 from device 100-1 is completed. In some embodiments, notification 598 is an updated session region 501 (e.g., an expanded session region). In some embodiments, a copy of photo 504 is displayed at device 580 after the transfer is completed (e.g., in addition to, or alternatively to, displaying photo 597 at device 100-4).

FIG. 5P illustrates device 5100, denoted “Tim's Laptop” positioned outside of proximity-initiated sharing range 570 of device 100-1. In the example of FIG. 5P, device 5100 has a local sharing mode enabled as indicated by element 5102 and device 100-1 has a sharing mode enabled as indicated by proximity indicator 530. In some embodiments, element 5102, when selected, causes the local sharing mode at device 5100 to toggle (e.g., toggle off). FIG. 5Q shows device 5100 within proximity-initiated sharing range 570 of device 100-1. FIG. 5Q further shows user interface 5104 at device 5100 indicating that the content sharing has completed (e.g., photo 504 has been received from device 100-1 via proximity-initiated sharing). In some embodiments, device 5100 displays a copy of photo 504 automatically when the transfer completes. In some embodiments, user interface 5104, when selected, causes display of a copy of photo 504 (e.g., via an image management application). FIG. 5Q also shows device 5100 at distance 5106 from device 100-1. In some embodiments, distance 5106 corresponds to a trigger distance for proximity-initiated sharing. In some embodiments, after device 5100 is moved to distance 5106 the transfer continues even if device 5100 moves beyond distance 5106 during the transfer. In some embodiments, distance 5106 is based on a device type of device 5100 and/or device 100-1. In some embodiments, distance 5106 is based on capabilities of one or more sensors in device 5100 and/or device 100-1. In some embodiments, the transfer of content in FIG. 5Q is performed in accordance with device 100-1 and/or device 5100 having a sharing mode enabled.

FIGS. 5R-5T illustrate example user interfaces and user interactions for broadcasting sharing availability and initiating local sharing of content in accordance with some embodiments. Device 5100 in FIG. 5R displays local sharing user interface 5110 that includes devices section 5114, people section 5116, and identifying section 5112. In some embodiments, in accordance with displaying user interface 5110, a sharing mode is enabled at device 5100. In some embodiments, the sharing mode includes enabling one or more wireless protocols (e.g., Bluetooth, Wi-Fi, and/or NFC protocols).

Devices section 5114 includes icons for devices associated with the same user account as device 5100, including an icon labeled “Mobile Phone”. In some embodiments, devices section 5114 includes devices that are available for local sharing of content. In some embodiments, one or more devices associated with the same user account are displayed in devices section 5114 even if not in proximity with device 5100. For example, a device associated with the same user account is displayed even if the device is not connected to the same wireless network and not directly connected to device 5100 (e.g., via a peer-to-peer wireless connection). In some embodiments, devices section 5114 includes devices associated with one or more user accounts that have an association with the user account of device 5100 (e.g., guest devices, temporary devices, and/or devices with other associations).

People section 5116 includes icons for contacts of device 5100. In some embodiments people section 5116 includes icons for contacts that are available for local sharing of content (e.g., via a peer-to-peer connection and/or via proximity-initiated sharing). In some embodiments, one or more contacts are displayed in people section 5116 even if not in proximity with device 5100. For example, a contact is displayed in people section 5116 even if a device of the contact is not connected to the same wireless network and not directly connected to device 5100 (e.g., via a peer-to-peer wireless connection). In some embodiments, people section 5116 includes icons for one or more contacts of device 5100 and/or icons for one or more devices available for local sharing of content with device 5100.

Identifying section 5112 includes information about how device 5100 is identified while broadcasting its share capabilities and/or engaging in content sharing with a remote device. In the example of FIG. 5R, identifying section 5112 includes an icon that indicates an image/avatar to be displayed during a subsequent broadcasting and/or sharing process and a name to be displayed during a subsequent broadcasting and/or sharing process. Identifying section 5112 also includes a selectable option (e.g., the right-facing arrow) to change and/or switch the identifying information (e.g., the icon and/or name).

FIG. 5R further shows element 5117 and element 5118 that, when selected, causes display of notification 5120 indicating that attempting to find nearby people by selecting element 5117 causes device 5100 to be visible to any nearby devices. FIG. 5R also shows user input 5122 selecting element 5117 to initiate a search for nearby devices (e.g., devices within a communicative coupling range).

FIG. 5S shows a transition from FIG. 5R in response to user input 5122. In FIG. 5S, device 5100 is searching for nearby devices, as indicated by text 5124. Text 5124 also indicates that 1 person (e.g., 1 device) is nearby in accordance with some embodiments. In some embodiments, nearby devices are included in text 5124 in response to (or in accordance with) the nearby device being available for local sharing of content. In some embodiments, the available nearby devices are listed in people section 5116 (e.g., with an icon for each device). FIG. 5S also shows done option 5126 for stopping the search for nearby people and user input 5128 selecting done option 5126. In some embodiments, a notification is displayed by device 5100 notifying the user that device 5100 is visible to nearby devices while searching.

FIG. 5T shows a transition from FIG. 5S in response to user input 5128. Device 5100 in FIG. 5T is no longer search for nearby people or devices. People section 5116 in FIG. 5T includes icon 5130 corresponding a nearby device that is available for sharing (e.g., corresponding to the 1 nearby person indicated in FIG. 5S). In some embodiments, icon 5130 is displayed in response to (or in accordance with) the nearby device becoming available for sharing content. In some embodiments, icon 5130 is displayed in response to user input 5128. In some embodiments, icon 5130, when selected, initiates a process to share content with the nearby device, labeled “Lauren.”

FIGS. 6A-6N illustrate example user interfaces and user interactions for sharing content and viewing shared content in accordance with some embodiments. FIG. 6A shows device 100 displaying screen 601 (e.g., a wake screen and/or lock screen) that includes notification 602 that another person, “Janet”, wants to share an image with the user of device 100. Notification 602 includes an indication of the content to be shared, including icon 604 (e.g., a thumbnail of the picture), decline option 608, and accept option 606. Decline option 608, when selected, causes the proposed content share to be declined (e.g., canceled). Accept option 606, when selected, initiates a process to transfer the content to device 100. In some embodiments, notification 602 is displayed in an updated session region 501. FIG. 6B shows device 100 displaying home screen 609 and notification 602. In the example of FIG. 6B, notification 602 is displayed in an updated session region 501. FIG. 6B further shows user input 610-1 selecting accept option 606 and user input 610-2 selecting decline option 608. User input 610-2 causes the proposed sharing of content to be declined (e.g., canceled). User input 610-1 initiates a process to transfer the content to device 100.

FIG. 6C shows a transition from FIG. 6B in response to user input 610-1. FIG. 6C corresponds to device 100 at a first time. Device 100 in FIG. 6C displays home screen 609 and notification 612 indicating that a transfer of content is in progress. In the example of FIG. 6B, notification 612 is displayed as (or in) an updated session region 501. Notification 612 includes icon 616 corresponding to the source of the transfer (e.g., an image and/or avatar for “Janet”) and progress indicator 614 (e.g., indicating a percentage of the transfer that has completed). In some embodiments, device 100 does not display notification 612 to indicate that the transfer is in progress.

FIG. 6D shows device 100 at a second time, subsequent to the first time. In the example of FIG. 6D, the transfer has completed as indicated by notification 618. In response to the transfer completing, device 100 displays user interface 620 (e.g., corresponding to an image management application) showing the received image 621. In some embodiments, image 621 is displayed automatically, without further user input, in response to the transfer being completed. In some embodiments, image 621 is displayed automatically in accordance with the transfer meeting one or more transfer criteria. In some embodiments, the one or more transfer criteria include a size of the content being less than a predefined threshold. In some embodiments, the one or more transfer criteria include a number of content items being less than a predefined threshold. In some embodiments, the one or more transfer criteria include a time to complete the transfer being less than a predefined threshold. In some embodiments, the one or more transfer criteria include a criterion based on the type of content being transferred. In the example of FIGS. 6A-6D a single photo is transferred from “Janet” to device 100.

FIG. 6E shows device 100 displaying home screen 609 and notification 624 indicating a share request from “Janet”. In the example of FIG. 6E, notification 624 is displayed as an updated session region 501. Notification 624 includes an indication of the content to be shared (e.g., 4 videos), including icon 626 (e.g., a thumbnail image), decline option 630, and accept option 628. Decline option 630, when selected, causes the proposed content share to be declined (e.g., canceled). Accept option 628, when selected, initiates a process to transfer the content to device 100. FIG. 6E further shows user input 632-1 selecting accept option 628 and user input 632-2 selecting decline option 630. User input 632-2 causes the proposed sharing of content to be declined (e.g., canceled). User input 632-1 initiates a process to transfer the content to device 100.

FIG. 6F shows a transition from FIG. 6E in response to user input 632-1. Device 100 in FIG. 6F displays home screen 609 and notification 634 indicating that a transfer of content is in progress. In the example of FIG. 6F, notification 634 is displayed as an updated session region 501. Notification 634 includes icon 638 corresponding to the source of the transfer (e.g., an image and/or avatar for “Janet”) and progress indicator 636 (e.g., indicating a percentage of the transfer that has completed). In some embodiments, notification 634 is displayed in accordance with a determination that the transfer meets one or more transfer criteria (e.g., based on an estimated time to complete the transfer, a size of the transfer, and/or other criteria). In some embodiments, notification 634 is displayed for a preset amount of time (e.g., 2 seconds, 5 seconds, or 10 seconds) or until the transfer completes if it is less than the preset amount of time. In some embodiments, notification 634 is displayed while the transfer is in progress, or until dismissed by the user of device 100. FIG. 6F further shows user input 640 on notification 634.

FIG. 6G shows a transition from FIG. 6F in response to user input 640. Device 100 in FIG. 6G displays home screen 609 and notification 642 (e.g., an expanded version of notification 634) indicating that a transfer of content is in progress. In the example of FIG. 6G, notification 642 is displayed as an updated session region 501. As shown in FIG. 6G, notification 642 includes additional details about the transfer that are not included in notification 634. In some embodiments, notification 642 is displayed for a preset amount of time (e.g., 2 seconds, 5 seconds, or 10 seconds) or until the transfer completes if it is less than the preset amount of time. In some embodiments, notification 642 is displayed while the transfer is in progress, or until dismissed by the user of device 100. In some embodiments, notification 642 is replaced with notification 634 if notification 642 is dismissed or the preset amount of time elapses. FIG. 6G also shows user input 643 (e.g., a swipe gesture) on notification 642 and user input 644 at a clock icon (e.g., corresponding to a timing application) on home screen 609. In some embodiments, user input 643 corresponds to a dismiss command for notification 642. In some embodiments, in response to detecting user input 643, notification 642 ceases to be displayed (e.g., notification 634 is displayed in place of notification 642).

FIG. 6H shows a transition from FIG. 6G in response to user input 644. FIG. 6H corresponds to device 100 at a third time. Device 100 in FIG. 6G displays user interface 646 (e.g., a user interface of, or corresponding to, the timing application) and notification 634. In some embodiments, notification 634 is displayed in place of notification 642 in response to user input 644. Notification 634 in FIG. 6H indicates that the transfer of content is ongoing. In some embodiments, notification 634 is displayed in place of notification 642 in response to a user input activating a function of device 100 that is separate from notification 642 (e.g., a function to activate a particular application and/or display a particular user interface). User interface 646 in FIG. 6H includes a timer with corresponding cancel and start options, a timer sound element, a world clock icon, an alarm icon, a stopwatch icon, and a timer icon. FIG. 6H further shows user input 647-1 selecting the start option, user input 647-2 selecting the timer sound element, and user input 647-3 selecting the world clock icon. In some embodiments, user input 647-1 causes the timer to start (e.g., begin counting down from 15 minutes). In some embodiments, user input 647-2 causes display of a user interface with options to change the type of alert that is presented when the timer ends (e.g., a particular sound, a particular type of vibration, and/or a particular image/video). In some embodiments, user input 647-3 causes display of a user interface that includes clocks for one or more locations (e.g., indicating the current time at each location).

FIG. 6I corresponds to device 100 at a fourth time, subsequent to the third time. In the example of FIG. 6I, the transfer has completed as indicated by notification 648. In the example of FIG. 6I, notification 648 is displayed as an updated session region 501. In accordance with some embodiments, device 100 does not automatically display the content when the transfer completes. In accordance with some embodiments, notification 648 is displayed overlaid over a portion of user interface 646. Notification 648 includes text notifying the user that the transfer has completed and view option 650. FIG. 6I further shows user input 652 selecting view option 650. In some embodiments, user input 652 causes display of at least a portion of the transferred content. In some embodiments, user input 652 causes display of at least a portion of the transferred content in accordance with a determination that user input 652 is a first type of input (e.g., a tap input). FIGS. 6A-6D illustrate an example where transferred content is displayed automatically as the transfer completes in accordance with the transfer meeting one or more transfer criteria, and FIGS. 6E-6I illustrate an example where transferred content is not displayed automatically as the transfer completes in accordance with the transfer not meeting one or more transfer criteria.

FIG. 6J shows a transition from FIG. 6I in response to user input 652. Device 100 in FIG. 6J displays user interface 653 (e.g., corresponding to an image management application). User interface 653 includes image 655 (e.g., a preview image for a video) and playback option 654. In some embodiments, playback option 654, when selected, causes playback of the video corresponding to image 655 (e.g., a video received from “Janet” via the content transfer initiated by user input 632-1). In some embodiments, in response to user input 652, playback of the video represented by image 655 starts automatically (e.g., without requiring a selection of playback option 654 or any other playback option).

FIG. 6K shows device 100 at the fourth time (corresponding to FIG. 6I). In the example of FIG. 6K, the transfer initiated by user input 632-1 has completed as indicated by notification 648. FIG. 6K further shows user input 658 selecting view option 650. User input 658 is a second type of input (e.g., a long press input), different from the first type of input (e.g., a short press input) of user input 652 in FIG. 6I.

FIG. 6L shows a transition from FIG. 6K in response to user input 658. Device 100 in FIG. 6L displays user interface 659 (e.g., a menu of options). In accordance with some embodiments, user interface 659 is displayed overlaid over at least a portion of notification 648 and at least a portion of user interface 646. User interface 659 includes option 660 to change a storage location for storing the transferred content (e.g., the videos from “Janet”), and option 662 to select an application to use to open the transferred content. FIG. 6L further shows user input 666-1 selecting option 660 and user input 666-2 selecting option 662. In some embodiments, user input 666-1 causes display of a user interface for selecting a storage location for the transferred content (and optionally an option to rename the transferred content items). In some embodiments, user input 666-2 causes display of a user interface with a listing of applications on device 100 that are capable of opening the transferred content (e.g., applications that are compatible with the content type of the transferred content).

FIG. 6M shows device 100 displaying user interface 620 with image 621, and notification 670 indicating a share request from “Janet”. In the example of FIG. 6M, notification 670 is displayed as an updated session region 501. Notification 670 includes an indication of the content to be shared (e.g., 1 image), including icon 676 (e.g., a thumbnail of the image to be shared), decline option 674, and accept option 672. Decline option 674, when selected, causes the proposed content share to be declined (e.g., canceled). Accept option 672, when selected, initiates a process to transfer the content to device 100. FIG. 6M further shows user input 678 selecting accept option 672.

FIG. 6N shows a transition from FIG. 6M in accordance with user input 678 selecting accept option 672. In the example of FIG. 6N, the transfer has completed as indicated by notification 680. In the example of FIG. 6N, notification 680 is displayed as an updated session region 501. In accordance with some embodiments, device 100 does not automatically display the content (e.g., the image) when the transfer completes. In accordance with some embodiments, notification 680 is displayed overlaid over a portion of user interface 620. Notification 680 includes text notifying the user that the transfer has completed, view option 682, and share option 684. In the example of FIG. 6N, device 100 does not replace display of image 621 with display of the image received in the transfer initiated by user input 678 in accordance with a determination that the user is currently viewing an image (e.g., a determination that user interface 620 corresponds to an image management application). FIG. 6N further shows user input 686-1 selecting view option 682 and user input 686-2 selecting share option 684. In some embodiments, user input 686-1 causes display of at least a portion of the transferred content (e.g., replacing display of image 621). In some embodiments, user input 686-2 initiates a process to share the received content with another person and/or device (e.g., causes display of a share interface such as user interface 510 in FIG. 5B).

FIGS. 7A-7I illustrate example user interfaces and user interactions for sharing contact information in accordance with some embodiments. FIG. 7A shows device 100-1, denoted “Max's Phone,” and device 100-3, denoted “Janet's Phone.” In the example of FIG. 7A, device 100-1 has completed transferring content (e.g., photo 504) to device 100-3, as indicated by notification 702 and notification 705. For example, FIG. 7A corresponds to a time subsequent to FIG. 5L. Device 100-1 in FIG. 7A displays user interface 528 and notification 702. Notification 702 includes contact information 704 for the user of device 100-1, option 708 to decline to share contact information 704, and option 706 to share contact information 704 with device 100-3. In some embodiments, option 708, when selected, causes notification 702 to cease to be displayed. In some embodiments, option 706, when selected, initiates a process to share contact information 704 with device 100-3. In some embodiments, device 100-3 displays a notification similar to notification 702 (e.g., with contact information for the user of device 100-3 and an option to share that contact information with device 100-1).

In some embodiments, notification 702 is displayed in response to a completion of a content share process (e.g., in response to device 100-3 receiving the shared content). In some embodiments, notification 702 is displayed in accordance with at least a portion of content being transferred. In some embodiments, notification 702 is displayed in accordance with a start of content being transferred. Device 100-3 shows photo 572 (e.g., corresponding to an image management application) and notification 705 that shared content has been received. In some embodiments, contact information 704 is default contact information (e.g., corresponds to a default profile for sharing contact information of the user or owner of device 100-1). In some embodiments, contact information 704 has previously been selected by the user to be used for subsequent contact sharing operations. FIG. 7A further shows user input 712 on notification 702.

FIG. 7B shows a transition from FIG. 7A at device 100-1 in response to user input 712. In accordance with some embodiments, user input 712 causes display of contact information user interface 714 (e.g., a profile page for the user of device 100-1). Contact information user interface 714 includes an image 715 (e.g., a photo of the user and/or avatar for the user), contact information 716, element 718 to edit contact information, option 722 to decline to share contact information, and option 720 to share contact information. In some embodiments, contact information 716 corresponds to contact information 704 (e.g., is a set of contact information selected to be shared). In some embodiments, contact information user interface 714 includes a dismiss option (e.g., option 722) that, when selected, causes contact information user interface 714 to cease to be displayed (e.g., causes user interface 528 to be displayed again). In some embodiments, contact information user interface 714 ceases to be displayed in response to a particular type of gesture (e.g., a swipe gesture). In some embodiments, option 722, when selected, causes contact information user interface 714 to cease to be displayed. In some embodiments, option 720, when selected, initiates a process to share contact information 716 with device 100-3. FIG. 7B further shows user input 724 selecting element 718.

FIG. 7C shows a transition from FIG. 7B in response to user input 724. Device 100-1 displays user interface 728 in FIG. 7C in response to detecting user input 724. User interface 728 includes a list of contact information fields 738. In the example of FIG. 7C, user interface 728 includes section 732 with name fields, section 734 with phone number fields, and section 736 with email fields. In some embodiments, user interface 728 includes a subset of the sections shown in FIG. 7C. In some embodiments, user interface 728 includes other sections not shown in FIG. 7C (e.g., a section with location fields). In some embodiments, user interface 728 does not include multiple sections. Each of the contact information fields 738 includes an indicator that indicates whether the respective field is selected for sharing. For example, FIG. 7C indicates that contact information field 738-1 is not selected for sharing and contact information fields 738-2 and 738-3 are selected for sharing. In accordance with some embodiments, a user input detecting at a respective contact information field causes selection of the field to toggle. In some embodiments, user interface 728 is displayed overlaid over at least a portion of contact information user interface 714. User interface 728 further includes done option 733. In some embodiments, done option 733, when selected, causes contact information 716 and/or contact information 704 to be updated in accordance with which fields in the list of contact information fields 738 are selected (e.g., selected prior to user selection of done option 733). In some embodiments, done option 733, when selected, causes user interface 728 to cease to be displayed. FIG. 7C further shows user input 739 selecting done option 733.

FIG. 7D shows a transition from FIG. 7C in response to user input 739. Device 100-1 displays user interface 714 in FIG. 7D in response to detecting user input 739. In some embodiments, contact information 716 is updated in accordance with the selected fields in the list of contact information fields 738 at the time user input 739 was detected. FIG. 7D further shows user input 740 selecting option 720 to share contact information.

FIG. 7E shows a transition from FIG. 7D in response to user input 740. Device 100-1 displays notification 742 in FIG. 7E and device 100-3 displays notification 746 in response to user input 740 in accordance with some embodiments. Notification 742 includes an indication that contact information of the user (e.g., contact information 716) is being offered to device 100-3 and option 744 to cancel the offer to share the contact information. FIG. 7E also shows user input 745 selecting option 744. In some embodiments, user input 745 causes the offer to share contact information with device 100-3 to be canceled (e.g., causing notification 746 to cease to be displayed). Notification 746 includes indication that device 100-1 is offering to share contact information, option 750 to decline to receive the contact information, and option 748 to accept the contact information. In the example of FIG. 7E, notification 746 is displayed as an updated session region 501. FIG. 7E also shows user input 752 selecting option 748 to accept the contact information from device 100-1.

FIG. 7F shows a transition from FIG. 7E in response to user input 752 in FIG. 7E, or a transition from FIG. 7D in response to user input 740. Device 100-3 in FIG. 7F has received contact information from device 100-1 in accordance with user input 752 or user input 740. In some embodiments, in response to user input 752 an acceptance of the offer is transmitted to device 100-1 and, in response, device 100-1 transmits the contact information to device 100-3. In some embodiments, device 100-1 transmits the contact information prior to user input 752 being detecting, and in response to detecting user input752, device 100-3 stores the contact information. FIG. 7F shows device 100-3 displaying user interface 754 (e.g., a contact page for Max Johnston). In some embodiments, user interface 754 is displayed automatically, without further user input, after detecting user input 752. In some embodiments, a notification is displayed in response to user input 752, the notification indicating that the contact information has been stored and including an option to view the contact information. In some embodiments, user interface 754 is displayed in response to a user selection of the option to view the contact information. User interface 754 includes image 756 (e.g., a photo and/or avatar of Max Johnston), name information 758, and contact information fields 760 (e.g., phone number, email address, mailing address, and/or other means of contacting the user). FIG. 7F also shows device 100-3 displaying user interface 762 for reciprocal sharing. In some embodiments, user interface 762 is a portion of user interface 754. In some embodiments, user interface 762 is overlaid over a portion of user interface 754. In some embodiments, user interface 762 is displayed as a notification. User interface 762 includes contact information for the user of device 100-3, option 766 to decline to share the contact information, and option 764 to share the contact information with device 100-1, and element 763 to edit the contact information to be shared. In some embodiments, option 766, when selected, causes user interface 762 to cease to be displayed. In some embodiments, option 764, when selected, initiates a process to share contact information with device 100-1. FIG. 7F further shows user input 770 selecting element 763.

FIG. 7G shows a transition from FIG. 7F in response to user input 770. Device 100-3 in FIG. 7G displays user interface 772 (e.g., a profile page for the user of device 100-3) that includes image 774 (e.g., a photo and/or avatar of Janet), contact information 776, element 778 to edit contact information 776, option 784 to decline to share contact information, and option 780 to share contact information. In some embodiments, user interface 772 includes a dismiss option that, when selected, causes contact information user interface 714 to cease to be displayed (e.g., causes user interface 754 to be displayed again). In some embodiments, user interface 772 ceases to be displayed in response to a particular type of gesture (e.g., a swipe gesture). In some embodiments, option 784, when selected, causes contact information user interface 772 to cease to be displayed. In some embodiments, option 780, when selected, initiates a process to share contact information 776 with device 100-1. FIG. 7G further shows user input 782 selecting option 780.

FIG. 7H shows a transition from FIG. 7G in response to user input 782. Device 100-1 displays notification 786 in FIG. 7H and device 100-3 displays notification 794 in response to user input 782 in accordance with some embodiments. Notification 794 includes an indication that contact information of the user (e.g., contact information 776) is being offered to device 100-1 and option 796 to cancel the offer to share the contact information. FIG. 7H also shows user input 798 selecting option 796. In some embodiments, user input 798 causes the offer to share contact information with device 100-1 to be canceled (e.g., causing notification 786 to cease to be displayed). Notification 786 includes an indication that device 100-3 is offering to share contact information, option 792 to decline to receive the contact information, and option 788 to accept the contact information. In the example of FIG. 7H, notification 786 is displayed as an updated session region 501. FIG. 7H also shows user input 790 selecting option 788 to accept the contact information from device 100-3.

FIG. 7I shows a transition from FIG. 7H in response to user input 790. Device 100-1 in FIG. 7I has received contact information from device 100-3 in accordance with user input 790. FIG. 7I shows device 100-1 displaying user interface 7100 (e.g., a contact page for Janet Chu). In some embodiments, user interface 7100 is displayed automatically, without further user input, after detecting user input 790. User interface 7100 includes an image (e.g., a photo and/or avatar of Janet Chu), name information, contact options 7106, and contact information fields. In some embodiments, each contact option, when selected, initiates a process to contact Max Johnston via a corresponding application. For example, contact option 7106-1 corresponds to an instant messaging application and contact information 7106-2 corresponds to a video chat application. FIG. 7I also shows device 100-3 displaying user interface 754 and notification 7102. Notification 7102 indicates that contact information (e.g., contact information 776) has been shared with device 100-1. In the example of FIG. 7I, notification 7102 is displayed as an updated session region 501.

FIGS. 8A-8C are flow diagrams illustrating method 800 for displaying shared content in accordance with some embodiments. Method 800 is performed at a first electronic device (e.g., multifunction device 100 or device 300) including, or in communication with, a display generation component and, optionally, a touch-sensitive surface. In some embodiments, the first electronic device is a desktop computer, a laptop computer, a tablet, a smartphone, a smart watch, or other computing device. In some embodiments, the display generation component is a touch-screen display. In some embodiments, the display is separate from a touch-sensitive surface. Some operations in method 800 are, optionally, combined and/or the order of some operations is, optionally, changed.

As described below, method 800 provides an improved interface for selectively displaying transferred files in accordance with time-based criteria. Selectively displaying transferred files provides an adaptive and more intuitive user experience while reducing the number of inputs needed to achieve such an experience, which enhances the operability of the device and makes the user-device interface more efficient (e.g., by helping the user to achieve an intended outcome and reducing user mistakes when operating/interacting with the device), which, additionally, reduces power usage and improves battery life of the device by enabling the user to use the device more quickly and efficiently.

In some embodiments, in accordance with a determination that the first electronic device and a second electronic device are (802) associated with a same user account, the first electronic device initiates a transfer without requesting permission from a user of the first electronic device. For example, in accordance with some embodiments, device 100-3 and device 100-1 in FIG. 5L are associated with the same user account and photo 504 is shared from device 100-1 to device 100-3 in response to device 100-3 being within proximity-initiated sharing range 570 (e.g., without requesting permission from the user of device 100-1 or a user of device 100-3). In some embodiments, the first electronic device forgoes displaying an option to permit the transfer in accordance with a determination that the first electronic device and the second electronic device are associated with the same user account. Automatically initiating the transfer (e.g., without requiring user input granting permission) allows for transferring content between multiple user devices, without requiring additional input from the user, thereby providing an intuitive user experience while reducing the number of inputs needed to achieve such an experience.

In some embodiments, in accordance with a determination that the first electronic device and the second electronic device are (804) not associated with a same user account, the first electronic device: causes display of an option to permit the transfer via a display generation component; detects a user input corresponding to selection of the option to permit the transfer; and initiates the transfer in response to detecting the user input corresponding to selection of the option to permit the transfer. For example, FIG. 5N shows device 580 being within proximity-initiated sharing range 570 of device 100-1 and device 580 displaying accept option 584 (e.g., in response to being within proximity-initiated sharing range 570). In some embodiments, the option to permit the transfer is displayed in a notification (e.g., a pop-up notification) that includes information about the transfer (e.g., information about the second electronic device and/or the respective content). For example, the notification includes a name of a user of the second electronic device. Providing a means for the user to permit the transfer of content enhances the operability of the device and makes the user-device interface more efficient (e.g., by helping the user to achieve an intended outcome and reducing user mistakes when operating/interacting with the device). Additionally, forgoing automatically transferring content between devices of different accounts improves security (e.g., avoiding the device receiving malicious or otherwise unwanted content).

The first electronic device receives (806) the transfer of respective content (e.g., pictures, documents, uniform resource locators (URLs), videos, and/or other content) from the second electronic device via a local connection.

In some embodiments, while receiving the transfer of the respective content, the first electronic device causes (808) display of a transfer indicator (e.g., notification 634, FIG. 6F) via the display generation component. In some embodiments, the transfer indicator includes an indication of the progress of the transfer (e.g., progress indicator 636). For example, the transfer indicator includes an indication of a transfer percentage, amount, rate, and/or other progress information. In some embodiments, the transfer indicator includes an identifier (e.g., icon 638) of a user of the second electronic device and/or an identifier of the second electronic device. In some embodiments, the transfer indicator includes a name and/or identifier of the respective content being transferred. Displaying a transfer indicator for a transfer of content reduces the number of inputs and the amount of display area needed for viewing feedback about a state of the device.

In some embodiments, while receiving the transfer of the respective content, the first electronic device detects (810) a second user input (e.g., user input 640, FIG. 6F) at a location that corresponds to the transfer indicator; and, in response to detecting the second user input, causes display of additional transfer information via the display generation component. As an example, in response to detecting user input 640 in FIG. 6F, session region 501 in FIG. 6G includes additional transfer information as compared to session region 501 in FIG. 6F. For example, the additional transfer information includes information about a user of the second electronic device, information about the second electronic device, information about the respective content, information about the transfer progress, other transfer information, an option to pause the transfer, an option to abort the transfer, and/or another transfer option. In some embodiments, the information about the transfer progress updates (e.g., in real time and/or automatically) as the transfer continues. In some embodiments, the information about the user of the second electronic device, the information about the second electronic device, the information about the respective content, the information about the transfer progress, the other transfer information, the option to pause the transfer, the option to abort the transfer, and/or the other transfer option(s) are displayed concurrently. As an example, the option to pause the transfer causes the transfer to be paused when selected and causes the transfer indicator to update to include a resume option to resume the transfer. As another example, selection of the option to abort the transfer, when selected, causes the transfer to be cancelled (and optionally, the portion of the respective content received at the first electronic device to be deleted). Changing which information is displayed in the status region, e.g., increasing the size of the status region (e.g., while displaying new information), visually emphasizes information that is more relevant and/or potentially of greater interest to the user, thereby providing feedback about a state of the device.

In some embodiments, while receiving the transfer of the respective content, the first electronic device detects (812) a third user input; and, in response to detecting the third user input, performs an operation (sometimes herein called the triggered operation) that corresponds to the third user input. For example, FIG. 6G shows user input 644 selecting a clock icon corresponding to a timing application and FIG. 6H shows device 100 displaying user interface 646 (e.g., a user interface of, or corresponding to, the timing application) in response to detecting user input 644. As another example, the operation corresponds to an action within an application executing on the first electronic device, corresponds to activating and/or switching to an application, corresponds to activation of a function of the first electronic device, and/or another type of operation. In some embodiments, the operation corresponding to the user input is performed independently of the transfer process (e.g., independent of the process that initiated the transfer). For example, the operation is performed independently of execution of an application used to display at least a portion of the respective content. Providing a means for the user to trigger operations of the device during the transfer of content enhances the operability of the device and makes the user-device interface more efficient (e.g., by helping the user to achieve an intended outcome, by performing two (or more) operations (e.g., transferring content, and the triggered operation) concurrently, and reducing user mistakes when operating/interacting with the devices).

In response to completion of the transfer of the respective content (814) and in accordance with a determination that the transfer meets one or more transfer magnitude criteria (e.g., based on a size of the transfer, a number of content items transferred, an actual time to complete the transfer, and/or an estimated time to complete the transfer), the first electronic device automatically (e.g., without further user input or directly in response to completing the transfer of the respective content) causes (816) display of at least a portion of the respective content (e.g., image 621, FIG. 6D) via the display generation component.

In response to completion the transfer of the respective content (814) and in accordance with a determination that the transfer does not meet the one or more transfer magnitude criteria, the first electronic device forgoes (818) automatically causing display of the at least a portion of the respective content via the display generation component.

In some embodiments, in response to completion of the transfer of the respective content and in accordance with the determination that the transfer meets the one or more transfer magnitude criteria and a determination that an application associated with the respective content is active, the first electronic device causes display of an option to view the respective content using the application (e.g., view option 682, FIG. 6N). Providing a means for the user to view transferred content in an active application enhances the operability of the device and makes the user-device interface more efficient (e.g., by helping the user to achieve an intended outcome and reducing user mistakes when operating/interacting with the device).

In some embodiments, in accordance with the determination that the transfer meets the one or more transfer magnitude criteria and the determination that the application associated with the respective content is active, the first electronic device forgoes (e.g., automatically) causing display of the at least a portion of the respective content via the display generation component. In some embodiments, in response to completion of a second transfer of second content, in accordance with a determination that the second transfer meets the one or more transfer magnitude criteria and a determination that an application associated with the second content is active, the first electronic device causes display of an option to view the second content within the application associated with the second content (e.g., which may be a different application than the application associated with the respective content). In some embodiments, in response to completion of the transfer of the respective content: in accordance with the determination that the transfer meets the one or more transfer magnitude criteria and a determination that the application associated with the respective content is not active, the first electronic device causes display of the at least a portion of the respective content via the display generation component. In some embodiments, in accordance with the determination that the transfer meets the one or more transfer magnitude criteria and a determination that the application associated with the respective content is not active, the first electronic device (e.g., automatically) activates the application to display the at least a portion of the respective content. In some embodiments, in accordance with the determination that the transfer meets the one or more transfer magnitude criteria and the determination that the application associated with the respective content is not active, the first electronic device forgoes displaying the option to view the respective content within the application.

In some embodiments, in response to completion the transfer of the respective content (814) and in accordance with the determination that the transfer does not meet the one or more transfer magnitude criteria, the first electronic device causes (820) an option (e.g., view option 650, FIG. 6I) to be displayed via the display generation component, where the option, when selected, causes display of at least a portion of the respective content via the display generation component (e.g., image 655, FIG. 6J). In some embodiments, the option is an option that, when selected, causes the respective content to be displayed in an application associated with a content type of the respective content. In some embodiments, a second option is displayed with the option, and the second option, when selected, causes the device to dismiss the user interface that includes the second option without displaying the respective content. Providing (e.g., automatically providing) a means for the user to view transferred content enhances the operability of the device and makes the user-device interface more efficient (e.g., by helping the user to achieve an intended outcome and reducing user mistakes when operating/interacting with the device).

In some embodiments, the first electronic device detects (822) a fourth user input corresponding to the option to display at least a portion of the respective content; in response to detecting the fourth user input and in accordance with a determination that the fourth user input has a first input type, causes display of at least a portion of the respective content in a first application; and in response to detecting the fourth user input and in accordance with a determination that the fourth user input has a second input type, distinct from the first input type, causes display of an option to view the respective content in a second application. For example, FIG. 6I shows user input 652 (e.g., a first type of input) and FIG. 6J shows device 100 displaying user interface 653 in response to detecting user input 652. To continue the example, FIG. 6K shows user input 658 (e.g., a second type of input) and FIG. 6L shows device 100 displaying user interface 659 in response to detecting user input 658. For example, the first input type is a tap, double tap, or other type of gesture. For example, the second input type is a long press, a deep press, or other type of gesture. For example, for the long press user input, the user maintains contact with the touch surface for at least a predefined threshold amount of time. In another example, for the deep press user input, the user input has an intensity that is at least a predefined intensity threshold. In these examples, a tap input is a user input that is maintained for less than the predefined threshold amount of time and/or has an intensity that is less than the predefined intensity threshold. In some embodiments, in accordance with the determination that the user input has the second input type, a list of applications for viewing the respective content is displayed. Performing different functions based on different types of user inputs provides improved control options for the user (e.g., an improved human-machine interface) without cluttering the display with additional/multiple displayed controls.

In some embodiments, the first electronic device causes (824) display of a notification via the display generation component, the notification including an option to share content from the first electronic device. For example, notification 680 in FIG. 6N includes share option 684. In some embodiments, the notification includes an option to move the respective content (e.g., store the respective content in a new storage location at the first electronic device). In some embodiments, the option to share content, when selected, causes display of a sharing user interface (e.g., with a plurality of options for sharing protocols and/or sharing contacts, as in user interface 510 in FIG. 5B). In some embodiments, the notification is displayed for a predetermined amount of time (e.g., 5 seconds, 10 seconds, or 20 seconds). In some embodiments, the first electronic device causes the notification to cease to be displayed a predetermined amount of time after causing display of the notification. Providing feedback (e.g., a notification) to the user enhances the operability of the device and makes the user-device interface more efficient (e.g., by helping the user to achieve an intended outcome and reducing user mistakes when operating/interacting with the device). Additionally, providing a means for the user to share content enhances the operability of the device and makes the user-device interface more efficient.

In some embodiments, the one or more transfer magnitude criteria include (826) a time-based criterion. In some embodiments, the time-based criterion corresponds to a threshold time to transfer (e.g., 0.5 seconds, 1 second, 2 seconds, 5 seconds, or 10 seconds). For example, if an estimated time to complete the transfer is longer than the threshold time, the transfer is determined to not meet the time-based criterion (e.g., and the first electronic device forgoes automatically causing display of the at least a portion of the respective content). In this example, if the estimated time to complete the transfer is shorter than the threshold time, the transfer is determined to meet the time-based criterion (e.g., and the first electronic device automatically causes display of the at least a portion of the respective content). In this way, the time-based criterion is based on a size of the respective content and a transfer speed for the transfer. Adjusting operation (e.g., automatically displaying transferred content) based on particular criteria (e.g., a time-based criterion) for a transfer enhances the operability of the device and makes the user-device interface more efficient.

In some embodiments, the one or more transfer magnitude criteria include (828) a size-based criterion and/or a content-type criterion. In some embodiments, the size-based criterion corresponds to a threshold size for the respective content. For example, if a size of the respective content is larger than the threshold size, the transfer is determined to not meet the size-based criterion. In this example, if a size of the respective content is smaller than the threshold size, the transfer is determined to meet the size-based criterion. In some embodiments, the content-type criterion corresponds to a file type for the respective content. For example, if a file type of the respective content is a first file type (e.g., a video file type, or a burst image file type), the transfer is determined to not meet the content-type criterion. In this example, if a file type of the respective content is a second file type (e.g., still image file type or a text file type), the transfer is determined to meet the content-type criterion. In some embodiments, the transfer magnitude criteria include one or more time-based criteria (e.g., an estimated time required to transfer the content), one or more size-based criteria (e.g., a file and/or folder size), and/or one or more content-type criteria (e.g., an image file, video file, text file, or other content type). Adjusting operation (e.g., automatically displaying transferred content) based on particular criteria (e.g., a size-based criterion and/or a content-type criterion) for a transfer enhances the operability of the device and makes the user-device interface more efficient.

In some embodiments, the transfer indicator is (830) caused to be displayed in accordance with a determination that the transfer does not meet the one or more transfer magnitude criteria. In some embodiments, in accordance with a determination that the transfer meets the one or more transfer magnitude criteria, the first electronic device forgoes causing display of the transfer indicator via the display generation component while receiving the transfer of the respective content. In some embodiments, a first type of transfer indicator is displayed for a transfer that meets the one or more transfer magnitude criteria; and a second type of transfer indicator is displayed for a transfer that does not meet the one or more transfer magnitude criteria. Displaying the transfer indicator (e.g., providing feedback to the user) when appropriate enhances the operability of the device and makes the user-device interface more efficient (e.g., by helping the user to achieve an intended outcome and reducing user mistakes when operating/interacting with the device).

In some embodiments, the transfer indicator is (832) displayed in a status region (e.g., session region 501). The status region is sometimes referred to as a dynamic window. In some embodiments, the status region is presented at an edge of a display (e.g., a top edge, a bottom edge, or other edge). In some embodiments, the device includes a session region that includes one or more sensors. In some embodiments, the one or more sensors are positioned within one or more cutouts (also called sensor regions) in a display of the device. In some embodiments, the status region encompasses the one or more cutouts for the one or more sensors and/or components (e.g., speaker 111 and/or optical sensor(s) 164). In some embodiments, additional sensors are located within the status region, such as a structured light emitter and/or projector). For example, the one or more additional sensors are positioned in the same cutout as the speaker, and/or in the same cutout as the optical sensor(s). In some embodiments, the transfer indicator includes a progress indicator that updates as the transfer progresses. In some embodiments, display of the transfer indicator is updated during the transfer to indicate a current status of the transfer. Displaying status information about a state of the first electronic device in a dedicated region provides an intuitive user experience, thereby helping the user achieve an intended outcome and reducing user mistakes.

In some embodiments, the status region further includes (834) display of information about one or more operations currently being performed by the first electronic device. For example, the information includes an indicator for connectivity of the first electronic device (e.g., a Bluetooth indicator, a Wi-Fi indicator, a cellular network indicator, or other type of connectivity indicator), a time indicator, a date indicator, a power source indicator, and/or other type of indicator. In some embodiments, the first electronic device displays, in the status region, status information about one or more software applications on the computer system. In some embodiments the status information about a respective application of the one or more software applications is displayed in accordance with a determination that the status region is associated with active session of the respective application. Changing which information is displayed in the status region in accordance with operation(s) currently being performed visually emphasizes information that is more relevant and/or of greater interest to the user, thereby providing improved feedback about a state of the device.

In some embodiments, the status region has (836) a size and/or position that is adjusted based on content displayed within the status region. For example, session region 501 in FIG. 6B has a first size that is based on content in notification 602, and session region 501 in FIG. 6C has a second size that is based on content in notification 612. In some embodiments, the status region has a size (e.g., a length and/or width) that is adjusted based on content presented within the region (e.g., content corresponding to active applications and/or functions). In some embodiments, a location of the status region is adjusted in accordance with touch locations. For example, the status region is displayed at a first display location in response to a first touch input at a first location and is displayed at a second display location in response to a second touch input at a second location. In some embodiments, a location and/or size of the status region is adjustable via touch inputs (e.g., drag and/or swipe inputs) at a display location of the status region. In some embodiments, the status region is displayed with a shape that includes a curvature that matches a curvature of the display (e.g., the corners of the display) of device, such as the shape of the corners of touch screen. In some embodiments, the status region maintains the curvature that matches the curvature of the display even as the status region is expanded to show additional information and/or controls for the session. In some embodiments, a status region that is displayed without active sessions (e.g., without status information), and/or status regions that are displayed with at least one active session (e.g., with status information), are displayed at a predefined position of the display as the user navigates between different user interfaces. For example, the status region is displayed within a same area of the display while the device displays application user interfaces, a home screen user interface, and optionally a wake screen user interface. Adjusting the sizing and/or positioning of the status region based on content (e.g., status information) enables the user to view additional feedback about a state of the device in a consistent region of the display, thereby providing improved feedback about a state of the device and reducing an amount of time needed to perform a particular operation in the device.

In some embodiments, the transfer is (838) performed via a short-range device-to-device communication protocol. In some embodiments, the transfer is performed using multiple distinct communication modes (e.g., Bluetooth, Wi-Fi, and/or NFC are used to complete the transfer). For example, the short-range device-to-device communication protocol is a Bluetooth protocol, a Wi-Fi protocol, or other type of communication protocol (e.g., NFC). In some embodiments, a first type of wireless communication is used to identify users with whom content can be shared directly, and a second type of wireless communication is used to perform the transfer. Providing a means for the user to transfer content via a device-to-device (e.g., direct) connection enhances the operability of the device (e.g., allowing for a transfer of content in the absence of a communications network) and improves privacy and/or security (e.g., by reducing the number of intermediary devices receiving and/or storing the content).

In some embodiments, the option to permit the transfer is (840) displayed on a wake screen of the first electronic device. For example, FIG. 6A shows device 100 displaying wake screen 601 and notification 602 that includes accept option 606. In some embodiments, the wake screen is a lock screen. For example, the wake screen is displayed before unlocking the first electronic device. In some embodiments, the option to permit the transfer is presented with an option to decline the transfer. In some embodiments, the wake screen is displayed on the first electronic device in accordance with activating a screen of the device while the device is in a low-power (e.g., sleep) state. Providing a means for the user to permit the transfer of content via a wake screen enhances the operability of the device and makes the user-device interface more efficient (e.g., allowing the user to permit the transfer without needing to first transition to another screen (e.g., a home screen)).

It should be understood that the particular order in which the operations in FIGS. 8A-8C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 900, 1000, and 1100) are also applicable in an analogous manner to method 800 described above with respect to FIGS. 8A-8C. For example, the inputs, gestures, functions, and feedback described above with reference to method 800 optionally have one or more of the characteristics of the inputs, gestures, functions, and feedback described herein with reference to other methods described herein (e.g., methods 900, 1000, and 1100). For brevity, these details are not repeated here.

FIGS. 9A-9C are flow diagrams illustrating method 900 for proximity-initiated content sharing in accordance with some embodiments. Method 900 is performed at an electronic device (e.g., multifunction device 100 or device 300) including, or in communication with, a display generation component and, optionally, a touch-sensitive surface. In some embodiments, the electronic device is a desktop computer, a laptop computer, a tablet, a smartphone, a smart watch, or other computing device. In some embodiments, the display generation component is a touch-screen display. In some embodiments, the display is separate from a touch-sensitive surface. Some operations in method 900 are, optionally, combined and/or the order of some operations is, optionally, changed.

As described below, method 900 provides an improved interface for sharing content between devices. The improved interface provides an adaptive and more intuitive user experience while reducing the number of inputs needed to achieve such an experience enhances the operability of the device and makes the user-device interface more efficient (e.g., by helping the user to achieve an intended outcome and reducing user mistakes when operating/interacting with the device), which, additionally, reduces power usage and improves battery life of the device by enabling the user to use the device more quickly and efficiently.

In some embodiments, prior to detecting a first input (discussed below with reference to operation 906 and 908), the electronic device causes (902) display of a second sharing interface (e.g., sharing user interface 510, FIG. 5B) via a display generation component, where the second sharing interface includes: identification of first content (e.g., photo 504), identification of one or more contacts (e.g., selectable icons 518), and one or more options for sharing the first content (e.g., options 524). In some embodiments, the identification of the first content includes an image of the first content and/or an identifier for the first content. In some embodiments, the identification of the one or more contacts includes a selectable icon for each contact. In some embodiments, the identification of the one or more contacts includes indication of a sharing method associated with each contact (e.g., sharing indicators 520). In some embodiments, the one or more options for sharing the first content include a messaging option (e.g., option 524-1), an e-mail option (e.g., option 524-3), a local sharing option (e.g., option 524-2), a social media sharing option, and/or other sharing options. Causing display of the second sharing interface enhances operability of the device (e.g., provides flexibility by reducing the number of inputs needed) and makes the user-device interface more efficient.

As an example, the electronic device detects a second input; and, in response to detecting the second input, in accordance with a determination that the second input selects a contact of the one or more contacts (e.g., in the second sharing interface), the electronic device initiates a process to share the first content with the selected contact (e.g., displays a user interface with one or more options for sharing the first content with the selected contact and/or causes a share request to be transmitted to an electronic device of the selected contact. To continue the example, in response to detecting the second input and in accordance with a determination that the second input selects an option of the one or more options, the electronic device initiates a process to share the first content via the selected option (e.g., the electronic device causes display of a user interface that corresponds to the selected option).

In some embodiments, in conjunction with causing display of the second sharing interface, the electronic device enables (904) a local sharing mode of the electronic device. In some embodiments, enabling the local sharing mode includes enabling one or more communication protocols (e.g., NFC, Bluetooth, Wi-Fi, and/or other protocols). In some embodiments, enabling the local sharing mode includes authorizing one or more communication protocols for use with sharing content (e.g., enabling a permission for the one or more communication protocols). Enabling the local sharing mode in conjunction with causing display of the second sharing interface (e.g., automatically) allows for transferring content between multiple user devices, without requiring additional input from the user, thereby providing an intuitive user experience while reducing the number of inputs needed to achieve such an experience.

The electronic device detects (906) a first input (e.g., user input 526-2, FIG. 5B) that corresponds to a request to initiate a process for sharing the first content (e.g., pictures, documents, uniform resource locators (URLs), videos, and/or other content).

In response to detecting the first input, the electronic device causes (908) display of a sharing interface (e.g., user interface 528, FIG. 5C) via the display generation component, where displaying the sharing interface includes concurrently displaying: one or more sharing options (e.g., device icon 533 and/or contact icon 535) for sharing content with other devices; and instructions for sharing content using a proximity-initiated sharing mode (e.g., instructions section 536). In some embodiments, the one or more sharing options are displayed in a first section of the sharing interface and the instructions are displayed in a second section of the sharing interface. In some embodiments, the one or more sharing options include an option for sharing with devices of a same user account, an option for sharing with nearby devices, and/or other sharing options. In some embodiments, the instructions include text instructions, pictorial instructions, and/or other types of instructions.

In some embodiments, prior to detecting the first input, a local sharing mode of the electronic device is disabled; and, in response to detecting the first input, the electronic device enables (910) the local sharing mode of the electronic device. In some embodiments, one or more communication protocols (e.g., near-field communication (NFC), Bluetooth, Wi-Fi, and/or other protocols) are enabled in response to the first input. Enabling the local sharing mode in conjunction with causing display of the sharing interface (e.g., automatically) allows for transferring content between multiple user devices, without requiring additional input from the user to enable the one or more communication protocols, thereby providing an intuitive user experience while reducing the number of inputs needed to achieve such an experience.

In some embodiments, in conjunction with enabling the local sharing mode, the electronic device causes (912) display, via the display generation component, of a visual indicator (e.g., proximity indicator 530, FIG. 5C) indicating that the local sharing mode is enabled. In some embodiments, the visual indicator is displayed while the local sharing mode is enabled (e.g., regardless of how the local sharing mode is enabled). Providing the visual indicator for the user enhances the operability of the device and makes the user-device interface more efficient (e.g., by helping the user to achieve an intended outcome and reducing user mistakes when operating/interacting with the device).

In some embodiments, in accordance with a user following the instructions, the electronic device shares (914) the first content to a user account associated with a nearby wearable electronic device. For example, FIG. 5O shows device 580 positioned with respect to device 100-1 as indicated by instructions section 536 (e.g., within proximity-initiated sharing range 570) and corresponding sharing of content (e.g., as indicated by notification 594). Providing a means for the user to share the first content with a nearby wearable device enhances the operability of the device and makes the user-device interface more efficient (e.g., by helping the user to achieve an intended outcome and reducing user mistakes when operating/interacting with the device).

In some embodiments, in accordance with a user following the instructions, the electronic device shares (916) the first content to a nearby electronic device. For example, FIG. 5L shows device 100-3 positioned with respect to device 100-1 as indicated by instructions section 536 (e.g., within proximity-initiated sharing range 570) and corresponding sharing of content (e.g., as indicated by photo 572 and notification 574). Providing a means for the user to share the first content with a nearby electronic device enhances the operability of the device and makes the user-device interface more efficient (e.g., by helping the user to achieve an intended outcome and reducing user mistakes when operating/interacting with the device).

In some embodiments, the electronic device detects (918) a second input (e.g., user input 544-3 or user input 544-2, FIG. 5C) at a sharing option of the one or more sharing options in the sharing interface (e.g., user interface 528, FIG. 5C); and, in response to detecting the second input, shares the first content via an application corresponding to the sharing option. For example, the application is a messaging application, an e-mail application, a social media application, or other type of application. In some embodiments, sharing the first content via the application comprises activating the application and/or presenting a user interface of the application. In some embodiments, the one or more options for sharing the first content correspond to respective transfer applications and/or transfer protocols for sharing content. For example, the electronic device detects a user input; and, in response to detecting the user input, in accordance with a determination that the user input selects an email option from the one or more options for sharing the first content, the electronic device initiates a process to share the first content via email (e.g., the electronic device causes display of a user interface that corresponds to an email application). To continue the example, in accordance with a determination that the user input selects a social media option from the one or more options for sharing the first content, the electronic device initiates a process to share the first content via a corresponding social media application (e.g., the electronic device causes display of a user interface that corresponds to the social media application). Providing a means (e.g., a sharing option on a same user interface as the instructions for proximity-initiated sharing mode) for the user to share the first content via an application corresponding to the sharing option enhances the operability of the device and makes the user-device interface more efficient (e.g., by helping the user to achieve an intended outcome and reducing user mistakes when operating/interacting with the device).

In some embodiments, causing display of the visual indicator includes (920) replacing display of a communication status indicator with the visual indicator. For example, display of proximity indicator 530 in FIG. 5C replaces display of connectivity indicator 514 in FIG. 5B. In some embodiments, causing display of the visual indicator includes ceasing to display the communication status indicator. In some embodiments, causing display of the visual indicator includes ceasing to display the communication status indicator at a first position, displaying the visual indicator in the first position, and optionally displaying the communication status indicator at a second position (e.g., concurrently with displaying the virtual indicator). In some embodiments, the communication status indicator is a wireless connection indicator (e.g., a Wi-Fi connection indicator, a cellular connection indicator, or other type of wireless connection indicator). Changing which information is displayed (e.g., the visual indicator or the communication status indicator) in accordance with a state of the device (e.g., enabling the local sharing mode) visually emphasizes information that is more relevant and/or of greater interest to the user, thereby providing improved feedback about a state of the device.

In some embodiments, the second sharing interface includes (922) a local sharing option (e.g., option 524-2, FIG. 5B); and the first input corresponds to selection of the local sharing option. For example, user input 526-2 selects option 524-2 in FIG. 5B. For example, activation of the local sharing option corresponds to a request to initiate (e.g., trigger or begin) a process to locally share the first content. In some embodiments, the local sharing option is an NFC-based sharing option. Providing a means for the user to select between various ways of sharing content enhances the operability of the device and makes the user-device interface more efficient (e.g., by helping the user to achieve an intended outcome and reducing user mistakes when operating/interacting with the device).

In some embodiments, the one or more sharing options for sharing content with other devices include (924) an option for sharing content with another electronic device associated with a same user account as the electronic device. For example, device icon 533 in FIG. 5C corresponds to a second phone of the user of device 100-1. For example, the electronic device detects a user input (e.g., user input 544-3) selecting the option for sharing content, and, in response to detecting the user input, initiates a process to share the first content with the other device (e.g., prompting the user to select a sharing protocol for sharing with the other device or automatically sharing the first content via a local connection). Providing a means (e.g., a sharing option) for the user to share content with other devices on the same user account enhances the operability of the device and makes the user-device interface more efficient (e.g., by helping the user to achieve an intended outcome and reducing user mistakes when operating/interacting with the device).

In some embodiments, the one or more sharing options for sharing content with other devices include (926) an option for sharing content with a second electronic device that is in proximity to the electronic device. For example, FIG. 5F shows user interface 528 including selectable icon 558 corresponding to device 100-2 (e.g., device 100-2 being within a local connection range of device 100-1). In some embodiments, the second electronic device is communicatively coupled to the electronic device via a device-to-device connection (e.g., via a Bluetooth, NFC, or other device-to-device protocol). For example, the electronic device detects a user input selecting the option for sharing content with the second electronic device, and, in response to detecting the user input, initiates a process to share the first content with the second electronic device (e.g., prompting the user to select a sharing protocol for sharing with the second electronic device, transmitting a share request to the second electronic device, and/or automatically sharing the first content via a local connection). Providing a means (e.g., a sharing option) for the user to share content with nearby devices enhances the operability of the device and makes the user-device interface more efficient (e.g., by helping the user to achieve an intended outcome and reducing user mistakes when operating/interacting with the device).

In some embodiments, the sharing interface further includes (928) information regarding a sharing profile to be used with sharing the first content. For example, the user information (e.g., name 541) in user interface 528 in FIG. 5C may correspond to a sharing profile. In some embodiments, the sharing profile includes a name of a user of the electronic device. In some embodiments, the sharing profile includes contact information for the user of the electronic device. Displaying the information regarding the sharing profile in the sharing interface enhances the operability of the device and makes the user-device interface more efficient (e.g., by helping the user to achieve an intended outcome and reducing user mistakes when operating/interacting with the device).

In some embodiments, the information regarding the sharing profile includes (930) an option to change the sharing profile. For example, FIG. 5C shows user interface 528 including identifying section 538 that includes ‘share as’ information and selectable option 540. In some embodiments, the option to change the sharing profile comprises an option to share the first content anonymously. In some embodiments, the option to change the sharing profile comprises an option to adjust what contact information is included in the sharing profile. In some embodiments, the electronic device detects a user input selecting the option to change the sharing profile (e.g., user input 564, FIG. 5I), and, in response to detecting the user input, the electronic device causes display of a user interface (e.g., user interface 566, FIG. 5J), via the display generation component, that enables the user to select which identifying information is to be included in the sharing profile (e.g., which identifying information is to be included in a subsequent share broadcast and/or share request). Providing a means for the user to change the sharing profile enhances the operability of the device and improves privacy (e.g., by enabling the user to share only the information they wish to share).

In some embodiments, the proximity-initiated sharing mode is (932) configured to share content with a nearby electronic device (e.g., device 100-3, FIG. 5L). For example, the nearby electronic device is a phone, a tablet, a laptop, a personal computer, or other type of electronic device. Providing a means for the user to share content with a nearby device enhances the operability of the device and makes the user-device interface more efficient (e.g., by helping the user to achieve an intended outcome and reducing user mistakes when operating/interacting with the device).

In some embodiments, the proximity-initiated sharing mode is (934) configured to share content with a nearby wearable electronic device (e.g., device 580, FIG. 5N). For example, the nearby wearable electronic device is a smartwatch, an electronic wristband, or other type of wearable device. Providing a means for the user to share content with a nearby wearable electronic device enhances the operability of the device and makes the user-device interface more efficient (e.g., by helping the user to achieve an intended outcome and reducing user mistakes when operating/interacting with the device).

In some embodiments, sharing the first content to the user account includes (936) sharing the first content to a second electronic device that is associated with the user account (e.g., the same user account that is associated with the electronic device). For example, FIG. 5O shows device 580 within proximity-initiated sharing range 570 and a corresponding sharing of content to device 100-4, which is outside of proximity-initiated sharing range 570. In the example of FIG. 5O device 580 and device 100-4 are associated with a same user account. In some embodiments, the second electronic device is paired with the wearable electronic device. For example, the second electronic device is a phone, a tablet, a laptop, a personal computer, or other type of electronic device. Providing a means for the user to share content with a second device associated with a same user account as the nearby electronic device enhances the operability of the device and makes the user-device interface more efficient (e.g., by helping the user to achieve an intended outcome and reducing user mistakes when operating/interacting with the device). Additionally, providing a means for the user of the second device to obtain the shared content at the second device by bringing a separate device near the electronic device enhances the operability of the second electronic device and the nearby device and makes the user-device interface more efficient (e.g., by helping the user to achieve an intended outcome and reducing user mistakes when operating/interacting with the device).

In some embodiments, the sharing interface includes (938) indication of one or more devices of known contacts (e.g., contact icon 535, FIG. 5C), where the one or more devices of known contacts are not in proximity with the electronic device. In some embodiments, a device being in proximity with the electronic device comprising the device being within a near-field communication (NFC) range. In some embodiments, indication of one or more devices of known contacts includes respective icons for the one or more devices of known contacts. In some embodiments, the electronic device detects a user input selecting an icon for a device of a known contact (e.g., user input 544-2, FIG. 5C), and, in response to detecting the user input, initiates a process to share the first content with the device of the known contact (e.g., prompting the user to select a sharing protocol for sharing with the device or sharing the first content via a predefined protocol and/or a predefined connection). Providing indication of the one or more devices of known contacts enhances the operability of the device and makes the user-device interface more efficient (e.g., by helping the user to achieve an intended outcome and reducing user mistakes when operating/interacting with the device).

In some embodiments, sharing the first content to the nearby electronic device includes (940) sharing the first content via a direct local network connection, for example, a device-to-device Wi-Fi connection, Bluetooth connection, or other type of direct location connection. In some embodiments, the direct local network connection is a wireless connection. Providing a means for the user to transfer content via a direct local network connection enhances the operability of the device (e.g., allowing for a transfer of content in the absence of a communications network) and improves privacy and/or security (e.g., by reducing the number of intermediary devices receiving and/or storing the content).

In some embodiments, sharing of the first content with the nearby electronic device is (942) initiated in accordance with the nearby electronic device and the electronic device being brought into a threshold proximity of one another. For example, FIGS. 5K and 5L show device 100-3 moving within proximity-initiated sharing range 570 of one another and a corresponding transfer of content (e.g., photo 572). In some embodiments, the sharing of the first content is initiated via a first protocol (e.g., using NFC) and transfer of the first content utilizes one or more different protocols (e.g., Bluetooth, Wi-Fi, cellular, or other protocol). In some embodiments, the first content is shared automatically (e.g., without further user input) (e.g., using NFC, Bluetooth, Wi-Fi, cellular, and/or other type of protocol) in accordance with the nearby electronic device and the electronic device being brought into proximity with one another. Sharing the first content in accordance with the device being brought into the threshold proximity (e.g., automatically) allows for transferring content between multiple user devices, without requiring additional input from the user, thereby providing an intuitive user experience while reducing the number of inputs needed to achieve such an experience.

In some embodiments, the threshold proximity is (944) based on a device type of the nearby electronic device. For example, FIG. 5L shows distance 576 corresponding to device 100-3, FIG. 5N shows distance 586 corresponding to device 580, and FIG. 5Q shows distance 5106 corresponding to device 5100. In some embodiments, distances 576, 586, and 5106 are different distances. For example, the threshold proximity is a first distance for wearable devices (e.g., 1, 2, or 5 inches), a second distance for mobile devices (e.g., 1, 2, or 5 feet), and/or a third distance for other devices (e.g., 4, 5, or 6 feet). For example, the threshold proximity has a first value for a phone and a second value for a tablet. Providing different thresholds for different types of devices provides an intuitive user experience, thereby helping the user achieve an intended outcome and reducing user mistakes.

It should be understood that the particular order in which the operations in FIGS. 9A-9C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 800, 1000, and 1100) are also applicable in an analogous manner to method 900 described above with respect to FIGS. 9A-9C. For example, the inputs, gestures, functions, and feedback described above with reference to method 900 optionally have one or more of the characteristics of the inputs, gestures, functions, and feedback described herein with reference to other methods described herein (e.g., methods 800, 1000, and 1100). For brevity, these details are not repeated here.

FIGS. 10A-10B are flow diagrams illustrating method 1000 for broadcasting sharing availability in accordance with some embodiments. Method 1000 is performed at a first electronic device (e.g., multifunction device 100 or device 300) including, or in communication with, a display generation component and, optionally, a touch-sensitive surface. In some embodiments, the first electronic device is a desktop computer, a laptop computer, a tablet, a smartphone, a smart watch, or other computing device. In some embodiments, the display generation component is a touch-screen display. In some embodiments, the display is separate from a touch-sensitive surface. Some operations in method 1000 are, optionally, combined and/or the order of some operations is, optionally, changed.

As described below, method 1000 provides an improved interface for selectively broadcasting a device's connectivity availability. Selectively broadcasting connectivity availability provides improved security/privacy by reducing/minimizing an amount of time the device is broadcasting its presence and connectivity, as well as reducing the number of inputs needed for the user to control the audio device, and enhancing the operability of the device.

The first electronic device detects (1002) a user input (e.g., user input 544-1, FIG. 5C) corresponding to a request to make the first electronic device available for local sharing of content.

In response to detecting the user input, the first electronic device broadcasts (1004) availability of the first electronic device for the local sharing of content (e.g., as indicated by searching section 546 of user interface 528, FIG. 5D).

While broadcasting the availability of the first electronic device, the first electronic device receives (1006) a communication from a second electronic device, the communication indicating that the second electronic device would like to participate in local sharing of content with the first electronic device. For example, device 100-2 transmits an acceptance in response to detecting user input 556-1 (FIG. 5E).

In some embodiments, while broadcasting the availability of the first electronic device, the first electronic device causes (1008) an option (e.g., cancel option 548, FIG. 5G) to be displayed at the first electronic device, the option, when selected, causing the availability of the first electronic device to cease being broadcast. For example, FIG. 5G shows option 548 displayed while device 100-1 is searching for nearby devices. In accordance with some embodiments, cancel option 548, when selected, causes device 100-1 to stop searching for nearby devices. Providing a means (e.g., a cancel option) for the user to cancel the broadcast enhances the operability of the device and makes the user-device interface more efficient (e.g., by helping the user to achieve an intended outcome and reducing user mistakes when operating/interacting with the device) as well as improving privacy and security.

In some embodiments, prior to detecting the user input, the first electronic device causes (1010) a notification to be displayed via the display generation component, the notification indicating that broadcasting the availability of the first electronic device causes the first electronic device to be discoverable by other devices. For example, FIG. 5R shows device 5100 displaying notification 5120 that indicates that searching for nearby devices (e.g., selection of element 5117) causes device 5100 to be seen by nearby devices. Providing feedback to the user (e.g., the notification) enhances the operability of the device and makes the user-device interface more efficient (e.g., by helping the user to achieve an intended outcome and reducing user mistakes when operating/interacting with the device).

In response to receiving the communication from the second electronic device, the first electronic device causes (1012) display of a share option (e.g., icon 558, FIG. 5F) via the display generation component, where the share option is selectable to initiate a process for sharing content with the second electronic device via the local sharing of content.

Without further user input (e.g., automatically), upon the first electronic device receiving (1006) from the second electronic device the communication indicating that the second electronic device would like to participate in local sharing of content with the first electronic device, the first electronic device ceases (1014) to broadcast the availability of the first electronic device for local sharing of content. For example, FIG. 5C shows user input 544-1 selecting search option 542, FIG. 5D shows device 100-1 searching in response to user input 544-1, FIG. 5E shows user input 556-1 selecting accept option 552 at device 100-2, and FIG. 5F shows user interface 528 including icon 558 and device 100-1 no longer searching (e.g., in response to receiving acceptance from device 100-2). In some embodiments, the local sharing of content is via a short-range wireless transmission protocol and/or peer-to-peer sharing, such as direct Wi-Fi, Bluetooth, NFC, and/or other protocol. In some embodiments, the sharing operation is initiated locally (e.g., via NFC, Bluetooth, or Wi-Fi) and continued via a different protocol that operates over a longer distance (e.g., via a cellular network, the Internet, and/or other networks.

In some embodiments, the first electronic device detects (1016) a user selection of the share option (e.g., a user selection of icon 558 in FIG. 5F); and, in response to detecting the user selection, initiates the process for sharing content with the second electronic device. In some embodiments, initiating the process comprises causing a notification to be displayed at the second electronic device indicating content to be shared and providing an option to a user of the second electronic device to accept the sharing. For example, the first electronic device detects a second user input, and, in response to detecting the second user input, in accordance with a determination that the second user input selects the share option, the first electronic device initiates the process for sharing content with the second electronic device. To continue the example, in accordance with a determination that the second user input selects a share option corresponding to a different nearby device, the first electronic device initiates the process for sharing content with the different nearby device. To continue the example further, in accordance with a determination that the second user input selects a share option corresponding to a contact of the user, the first electronic device initiates the process for sharing content with the contact of the user (e.g., transmits a request to share content to a device of the contact of the user and/or transmits the content to be shared to the device of the contact of the user). Providing a means (e.g., a share option) for the user to share content with a second electronic device enhances the operability of the device and makes the user-device interface more efficient (e.g., by helping the user to achieve an intended outcome and reducing user mistakes when operating/interacting with the device).

In some embodiments, after broadcasting availability of the first electronic device for the local sharing of content and in accordance with not receiving the communication from the second electronic device, the first electronic device forgoes causing display of the share option. For example, in accordance with user input 556-2 at decline option 554 (FIG. 5E), device 100-2 does not transmit a response to device 100-1, and therefore device 100-1 does not display an option for sharing with device 100-2 (e.g., does not display icon 558). In some embodiments, in accordance with not receiving a communication from any nearby device after broadcasting the availability, the first electronic device causes display of a notification indicating that no device responded to the broadcast. For example, FIG. 5H shows notification 562 displayed in accordance with not receiving a communication from a nearby device. Forgoing causing display of the share option in accordance with not receiving the communication from the second electronic device provides improved control options for the user of the first electronic device (an improved human-machine interface) without cluttering the display with additional/multiple displayed controls, and improves privacy and security for the user of the second electronic device.

In some embodiments, the availability of the first electronic device is (1018) broadcast for a preset amount of time (e.g., the scanning period indicated by notification 562, FIG. 5H). For example, the availability is broadcast for 30 seconds, 1 minute, 2 minutes, 5 minutes, or 10 minutes. In some embodiments, the availability of the first electronic device ceases to be broadcast in accordance with an elapsed amount of time meeting one or more criteria. For example, the one or more criteria include a time threshold that is based on a device type of the first electronic device. As another example, the one or more criteria include a time threshold that is based on a device setting of the first electronic device (e.g., a device setting that is based on one or more user preferences). Automatically ceasing to broadcast after the preset amount of time enhances the operability of the device (providing an intuitive user experience while reducing the number of inputs needed to achieve such an experience) and improves privacy and/or security (e.g., by reducing unintended broadcasting).

In some embodiments, the availability of the first electronic device ceases (1020) to be broadcast in response to receiving the communication from the second electronic device. For example, FIG. 5F shows user interface 528 including icon 558 and no longer searching (e.g., in response to receiving acceptance from device 100-2). In some embodiments, the availability ceases to be broadcast a preset amount of time after receiving the communication from the second electronic device. Automatically ceasing to broadcast in response to receiving the communication from the second electronic device enhances the operability of the device (e.g., providing an intuitive user experience while reducing the number of inputs needed to achieve such an experience) and improves privacy and/or security (e.g., by reducing unintended broadcasting).

In some embodiments, the second electronic device displays (1022) a local sharing notification (e.g., notification 550, FIG. 5E) in response to receiving the broadcast availability of the first electronic device. In some embodiments, the second electronic device, in response to receiving the broadcast availability of the first electronic device, displays a local sharing notification. For example, the local sharing notification indicates that a nearby user wants to share content. In some embodiments, the local sharing notification includes an identifier for the first electronic device and/or a name of a user of the first electronic device. For example, notification 550 in FIG. 5E includes the name of the user of device 100-1 (e.g., “Max Johnston”). In some embodiments, the first electronic displays a local sharing notification in response to receiving a broadcast availability from another electronic device. Providing the location sharing notification to the user of the second electronic device enhances the operability of the second electronic device and makes the user-device interface more efficient (e.g., by helping the user to achieve an intended outcome and reducing user mistakes when operating/interacting with the device).

In some embodiments, the communication from the second electronic device is (1024) transmitted in response to a user selection of the local sharing notification (e.g., user input 556-1, FIG. 5E). Providing a means (e.g., via the user selection of the local sharing notification) for the second electronic device to become visible for a subsequent transfer of content enhances the operability of the device and makes the user-device interface more efficient (e.g., by helping the user to achieve an intended outcome and reducing user mistakes when operating/interacting with the device).

In some embodiments, the local sharing notification is (1026) displayed in a status region (e.g., session region 501, FIG. 5A) of a display of the second electronic device. For example, the local sharing notification includes an option to open a user interface with more information regarding the broadcast availability and/or local sharing options. Displaying the local sharing notification in a dedicated region provides an intuitive user experience, thereby helping the user achieve an intended outcome and reducing user mistakes

In some embodiments, the local sharing notification is (1028) displayed in a control user interface of the second electronic device. For example, a local sharing notification may be displayed in control user interface 531 (FIG. 5K). Displaying the local sharing notification in a control user interface provides an intuitive user experience, thereby helping the user achieve an intended outcome and reducing user mistakes

In some embodiments, the local sharing notification includes (1030) an option (e.g., accept option 552, FIG. 5E) to respond to the broadcast availability; and the option to respond, when selected, causes the communication from the second electronic device to be transmitted. For example, FIG. 5E shows user input 556-1 selecting accept option 552 (e.g., causing transmission of an acceptance for sharing) and FIG. 5F shows user interface 528 including icon 558 (e.g., in response to receiving the acceptance for sharing). For example, the communication from the second electronic device is transmitted in response to a user selection of the option to respond. Providing a means (e.g., the option to respond) for the second electronic device to become visible for a subsequent transfer of content enhances the operability of the device and makes the user-device interface more efficient (e.g., by helping the user to achieve an intended outcome and reducing user mistakes when operating/interacting with the device).

In some embodiments, the share option (e.g., icon 558, FIG. 5F) is (1032) displayed within a sharing user interface (e.g., user interface 528, FIG. 5F); and the sharing user interface further includes one or more options (e.g., contact icon 535, FIG. 5F) for sharing content with one or more contacts of a user of the first electronic device. Providing a means (e.g., an option within the sharing user interface) for the user to share content with one or more contacts of the user enhances the operability of the device and makes the user-device interface more efficient (e.g., by helping the user to achieve an intended outcome and reducing user mistakes when operating/interacting with the device).

In some embodiments, the share option is (1034) displayed within a sharing user interface (e.g., user interface 528, FIG. 5F); and the sharing user interface further includes one or more options for sharing content with one or more other nearby devices (e.g., device icon 533, FIG. 5F). For example, the one or more options include an option to share content with a device in NFC, Bluetooth, and/or Wi-Fi Direct range of the first electronic device. In some embodiments, the one or more options for sharing the content include respective selectable elements for each of the one or more nearby devices. As an example, the first electronic device detects a second user input (e.g., a tap input, long press input, or other type of input); and, in response to detecting the second user input, in accordance with a determination that the second user input selects a selectable element corresponding to a first respective device of the one or more other nearby devices, the first electronic device initiates a process to share the content with the first respective device (e.g., causes display of a user interface (e.g., prompting the user to select a sharing protocol for sharing with the first respective device, transmitting a share request to the first respective device, and/or sharing the content with the first respective device via a local connection). To continue the example, in accordance with a determination that the second user input selects a selectable element corresponding to a second respective device of the one or more other nearby devices, the first electronic device initiates a process to share the content with the second respective device. In some embodiments, selection of two or more devices of the one or more other nearby devices initiates one or more processes for sharing the content with each of the two or more devices. Providing a means (e.g., an option within the sharing user interface) for the user to share content with nearby devices enhances the operability of the device and makes the user-device interface more efficient (e.g., by helping the user to achieve an intended outcome and reducing user mistakes when operating/interacting with the device).

It should be understood that the particular order in which the operations in FIGS. 10A-10B have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 800, 900, and 1100) are also applicable in an analogous manner to method 1000 described above with respect to FIGS. 10A-10B. For example, the inputs, gestures, functions, and feedback described above with reference to method 1000 optionally have one or more of the characteristics of the inputs, gestures, functions, and feedback described herein with reference to other methods described herein (e.g., methods 800, 900, and 1100). For brevity, these details are not repeated here.

FIGS. 11A-11C are flow diagrams illustrating method 1100 for sharing contact information in accordance with some embodiments. Method 1100 is performed at a first electronic device (e.g., multifunction device 100 or device 300) including, or in communication with, a display generation component and, optionally, a touch-sensitive surface. In some embodiments, the first electronic device is a desktop computer, a laptop computer, a tablet, a smartphone, a smart watch, or other computing device. In some embodiments, the display generation component is a touch-screen display. In some embodiments, the display is separate from a touch-sensitive surface. Some operations in method 1100 are, optionally, combined and/or the order of some operations is, optionally, changed.

As described below, method 1100 provides an improved interface for sharing contact information with another user after sharing content. Sharing contact information in such a manner provides an adaptive and more intuitive user experience while reducing the number of inputs needed to achieve such an experience enhances the operability of the device and makes the user-device interface more efficient (e.g., by helping the user to achieve an intended outcome and reducing user mistakes when operating/interacting with the device), which, additionally, reduces power usage and improves battery life of the device by enabling the user to use the device more quickly and efficiently.

The first electronic device detects (1102) a request to initiate a process for sharing one or more content items from the first electronic device to a second electronic device (e.g., as indicated by notification 602, FIG. 6A).

In response to the request to initiate the process for sharing the one or more content items, the first electronic device initiates (1104) the process to share the one or more content items between the first electronic device and the second electronic device. For example, device 100 initiates the process to share the one or more content items in response to user input 610-1 in FIG. 6B. As another example, device 100-1 initiates the process to share the one or more content items in response to selection of selectable icon 558 in FIG. 5G.

After sharing at least a portion of the one or more content items based on the request to initiate the process for sharing the one or more content items (1106) and in accordance with a determination that one or more contact sharing criteria are met, the first electronic device causes (1108) display, via the display generation component, of an option (e.g., option 706, FIG. 7A) to share contact information with the second electronic device, the contact information corresponding to a user of the first electronic device.

After sharing at least a portion of the one or more content items based on the request to initiate the process for sharing the one or more content items (1106) and in accordance with a determination that one or more contact sharing criteria are not met, the first electronic device forgoes (1110) causing display, via the display generation component, of the option to share the contact information with the second electronic device. In some embodiments, the request to initiate a process for sharing one or more content items corresponds to a user selection of a sharing option (e.g., one of options 524 or icons 518 in FIG. 5B, device icon 533 or contact icon 535 in FIG. 5C, or other sharing option). In some embodiments, the request to initiate a process for sharing one or more content items corresponds to activation of a sharing mode. In some embodiments, the request to initiate a process for sharing one or more content items corresponds to two devices being brought within a proximity initiated sharing range (e.g., proximity-initiated sharing range 570) while a sharing mode is enabled (e.g., as illustrated in FIGS. 5K-5L). In some embodiments, the option to share contact information is displayed after the one or more content items are shared (e.g., after sharing is completed).

In some embodiments, the first electronic device detects (1112) a user input selecting the option to share the contact information with the second electronic device; and, in response to detecting the user input, communicates the contact information to the second electronic device. For example, the contact information is transmitted to the second electronic device using a same protocol (e.g., Bluetooth, Wi-Fi, cellular, and/or other communication protocol) and/or connection (e.g., a local connection, device-to-device connection, and/or other type of connection) as was used to share at least the portion of the one or more content items. As another example, the contact information is transmitted to the second electronic device using a predefined communication protocol. Automatically providing a means (e.g., the option to share the contact information) for the user to share contact information with a second electronic device given the satisfaction of certain criteria provides an intuitive user experience while reducing the number of inputs needed to achieve such an experience.

In some embodiments, the second electronic device, which has received the contract information from the first electronic device, displays (1113) a contact user interface (e.g., notification 746, FIG. 7E) including an option (e.g., option 748) to store the contact information in response to receiving the contact information. In some embodiments, the second electronic device, in response to receiving the contact information, displays a contact user interface including an option to store the contact information. In some embodiments, the option to store the contact information comprises an option to store the contact information at the second electronic device. In some embodiments, the option to store the contact information comprises an option to store the contact information in a list of contacts associated with a user account of the second electronic device. Providing a means for the user of the second electronic device to store the contact information enhances the operability of the second electronic device and makes the user-device interface more efficient (e.g., by helping the user to achieve an intended outcome and reducing user mistakes when operating/interacting with the device).

Similarly, at the first electronic device, in response to receiving contact information from another electronic, e.g., in conjunction with a request by the other device to share one or more content items, the first electronic device displays a contact user interface including an option to store the contact information. In some embodiments, the contact user interface displayed by the first electronic device includes a second option to edit the contact information.

In some embodiments, the contact user interface further includes (1114) a second option to edit the contact information. For example, FIG. 7B shows contact information user interface 714 including element 718 to edit contact information. In some embodiments, the second electronic device detects a user input selecting the second option to edit the contact information, and, in response to detecting the user input, the second electronic device displays a user interface (e.g., user interface 728) that includes one or more options to select and/or deselect portions (e.g., particular fields) of a user's contact information. In some embodiments, only selected portions of the contact information are shared with the second electronic device. For example, FIG. 7C shows a subset of contact information fields 738 being selected. Accordingly, a subsequent selection of option 720 in FIG. 7D causes non-selected contact information fields 738 to be excluded from the sharing process (e.g., only selected contact information fields 738 are included in the sharing process). Providing a means (e.g., the second option to edit the contact information) for the user to edit the contact information to be shared enhances the operability of the device and improves privacy (e.g., by enabling the user to share only the information they wish to share).

In some embodiments, in conjunction with (e.g., after, while, or in response to) communicating the contact information to the second electronic device, the first electronic device causes (1115) a cancel option (e.g., option 744, FIG. 7E) to be displayed via the display generation component, the cancel option, when selected, causing the option to store the contact information to cease to be displayed by the second electronic device. In some embodiments, selection of the option to store the contact information causes a notification to be communicated to the first electronic device and/or causes the cancel option to cease to be displayed. Providing a means (e.g., a cancel option) for the user to cancel the sharing of contact information enhances the operability of the device and makes the user-device interface more efficient (e.g., by helping the user to achieve an intended outcome and reducing user mistakes when operating/interacting with the device) as well as improving privacy and security.

In some embodiments, the first electronic device detects (1116) a user input (e.g., user input 724, FIG. 7B) selecting a second option to change the contact information to be shared; and, in response to detecting the user input, causes a contact information user interface (e.g., user interface 728, FIG. 7C) to be displayed via the display generation component, where the contact information user interface indicates contact information to be shared (e.g., selected contact information fields 738-2 and 738-3). For example, the user input is a tap input, a double tap input, a long press input, a deep press input, or other type of input. Providing a means for the user to change contact information to be shared enhances the operability of the device and improves privacy (e.g., by enabling the user to share only the information they wish to share).

In some embodiments, the contact information user interface (e.g., user interface 728, FIG. 7C) further includes (1134) respective options for contact items of the contact information to be shared, where selection of an option of the respective options causes a corresponding contact item to not be included in the contact information to be shared. For example, the first electronic device detects a user input, and in response to detecting the user input, in accordance with a determination that the user input selects a first contact item (e.g., contact information field 738-1, FIG. 7C) the first electronic device toggles selection of the first contact item. To continue the example, in accordance with a determination that the user input selects a second contact item (e.g., contact information field 738-2) the first electronic device toggles selection of the second contact item. In some embodiments, selection of a first contact item causes deselection of a second contact item (e.g., only a threshold number (such as 1 or 2) of a particular set of contact items is selectable at a time, such as only 1 name option for the user). In some embodiments, non-selected contact items are excluded from being transferred in conjunction with a subsequent contact sharing operation. Providing a means (e.g., the respective options for contact items of the contact information to be shared) for the user to edit the contact information to be shared enhances the operability of the device and improves privacy (e.g., by enabling the user to share only the information they wish to share).

In some embodiments, the contact information user interface further includes (1136) indication of a set of contact information not selected to be shared. For example, user interface 728 in FIG. 7C indicates that contact information field 738-1 is not selected to be shared (e.g., the circle icon for contact information field 738-1 is not filled in). For example, the set of contact information not selected by default and/or in accordance with one or more previous user inputs. In some embodiments, each contact field in the set of contact information has an option to be included in or excluded from a subsequent sharing operation. For example, in response to a user selection of a contact field, a selection of the contact field is toggled. Providing the indication of a set of contact information not selected to be shared to the user enhances the operability of the device and makes the user-device interface more efficient (e.g., by helping the user to achieve an intended outcome and reducing user mistakes when operating/interacting with the device).

In some embodiments, the contact information user interface further includes (1138) respective options for contact items of the set of contact information, where selection of an option of the respective options causes a corresponding contact item to be included in the contact information to be shared. In some embodiments, contact items include one or more fields with user information and/or device information. For example, the contact items may include a name of the user, a title of the user, a contact method for the user (e.g., a phone number, an e-mail address, a mailing address, or other contact method), a user photo, a user avatar, and/or other contact information fields. In some embodiments, the first electronic device detects a user input, and, in response to detecting the user input, in accordance with a determination that the user input selects a first contact item of the set of contact items, selecting the first contact item and including the first contact item in a subsequent contact sharing operation. In some embodiments, in response to detecting the user input, in accordance with a determination that the user input selects a second contact item of the set of contact items, selecting the second contact item and including the second contact item in a subsequent contact sharing operation. Providing a means (e.g., respective options for contact items of the set of contact information) for the user to edit the contact information to be shared enhances the operability of the device and improves privacy (e.g., by enabling the user to share only the information they wish to share).

In some embodiments, the one or more contact sharing criteria include (1118) a criterion that the contact information has not previously been shared with the second electronic device. In some embodiments, the one or more contact sharing criteria include a criterion that the contact information has not previously been shared or offered to be shared with a user of the second electronic device. For example, if the user of the second electronic device previously ignored and/or declined an offer to share contact information then the option is not offered again. In some embodiments, the one or more contact sharing criteria include a criterion based on a privacy setting of the user and/or a privacy setting of a user of the second electronic device. For example, a privacy setting for a user of the first electronic device, or the second electronic device, when enabled, indicates that the user does not wish to share their contact information and/or does not wish to receive contact information from others. In this example, in accordance with a determination that the privacy setting is enabled, the first electronic device forgoes causing display of the option to share the contact information, and, in accordance with a determination that the privacy setting is disabled, the first electronic device causes display of the option to share the contact information. Automatically displaying of the option to share contact information (e.g., without requiring user input granting permission) based on a criterion that the contact information has not previously been shared allows provides an intuitive user experience while reducing the number of inputs needed to achieve such an experience.

In some embodiments, the contact information includes (1124) a name of the user of the first electronic device. For example, contact information 704 in FIG. 7A includes Max Johnston, the name of the user of device 100-1. For example, the contact information includes a first name, a last name, a full name, a nickname, or other name of the user.

In some embodiments, the contact information includes (1126) an identifier for communicating with the user of the first electronic device. For example, contact information 716 in FIG. 7B includes an email address for the user of device 100-1. For example, the identifier is a phone number, an email address, a mailing address, an identifier for a messaging service, an identifier for a social network, or other type of communication identifier.

In some embodiments, the contact information includes (1128) a visual representation of the user of the first electronic device (e.g., image 715, FIG. 7B). For example, the visual representation includes a photo of the user of the first electronic device and/or an avatar of the user of the first electronic device). For example, the avatar is selected and/or created by the user of the first electronic device.

In some embodiments, the contact information includes (1130) a phone number of the user of the first electronic device in accordance with a default setting. For example, contact information 704 in FIG. 7A includes a phone number for the user of device 100-1. In some embodiments, the user of the first electronic device designates default contact information.

In some embodiments, the option to share the contact information is (1132) displayed in a user interface (e.g., user interface 714, FIG. 7B); and the user interface further includes a second option to change the contact information to be shared (e.g., element 718). In some embodiments, in response to a first type of user input (e.g., a tap input, a double tap input, a long press input, or other type of input) at the user interface, the first electronic device causes display of a second user interface (e.g., user interface 728, FIG. 7C) for changing the contact information to be shared. Providing a means (e.g., the second option to change the contact information to be shared in the user interface) for the user to change the contact information to be shared enhances the operability of the device and makes the user-device interface more efficient.

In some embodiments, the second electronic device displays (1140) an option (e.g., option 764, FIG. 7F) to share second contact information with the first electronic device, the second contact information corresponding to a user of the second electronic device. In some embodiments, the second electronic device causes display of an option to share second contact information with the first electronic device, the second contact information corresponding to a user of the second electronic device. In some embodiments, the display of the option to share second contact information is via a second display generation component of, or in communication with, the second electronic device. In some embodiments, the display of the option to share the second contact information occurs after sharing the at least a portion of the one or more content items. In some embodiments, the display of the option to share the second contact information is caused in accordance with a determination that one or more second contact sharing criteria are met. In some embodiments, the display of the option to share the second contact information is caused in response to a user of the second electronic device accepting and/or storing the contact information from the first electronic device. In some embodiments, the display of the option to share the second contact information is caused in response to receiving the contact information from the first electronic device. Displaying the option to share second contact information with the first electronic device provides an improved interface for sharing contact information with another user after sharing content.

It should be understood that the particular order in which the operations in FIGS. 11A-11C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 800, 900, and 1000) are also applicable in an analogous manner to method 1100 described above with respect to FIGS. 11A-11C. For example, the inputs, gestures, functions, and feedback described above with reference to method 1100 optionally have one or more of the characteristics of the inputs, gestures, functions, and feedback described herein with reference to other methods described herein (e.g., methods 800, 900, and 1000). For brevity, these details are not repeated here.

The operations described above with reference to FIGS. 8A-8C, 9A-9C, 10A-10B, and 11A-11C are, optionally, implemented by components depicted in FIGS. 1A-1B, 2, and/or 3. For example, detection operation 1002 and broadcast operation 1004 are, optionally, implemented by event sorter 170, event recognizer 180, and event handler 190. Event monitor 171 in event sorter 170 detects a contact on touch-sensitive display system 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B, 2, and/or 3.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1-23. (canceled)

24. A method, comprising:
at a first electronic device that includes or is in communication with a display generation component:
receiving a transfer of respective content from a second electronic device via a local connection; and
in response to completion of the transfer of the respective content:
in accordance with a determination that the transfer meets one or more transfer magnitude criteria, automatically causing display of at least a portion of the respective content via the display generation component; and
in accordance with a determination that the transfer does not meet the one or more transfer magnitude criteria, forgoing automatically causing display of the at least a portion of the respective content via the display generation component.

25. The method of claim 24, wherein the one or more transfer magnitude criteria include a time-based criterion.

26. The method of claim 24, wherein the one or more transfer magnitude criteria include a size-based criterion and/or a content-type criterion.

27. The method of claim 24, further comprising, while receiving the transfer of the respective content, causing display of a transfer indicator via the display generation component.

28. The method of claim 27, wherein the transfer indicator is caused to be displayed in accordance with a determination that the transfer does not meet the one or more transfer magnitude criteria.

29. The method of claim 27, wherein the transfer indicator is displayed in a status region.

30. The method of claim 29, wherein the status region further includes display of information about one or more operations currently being performed by the first electronic device.

31. The method of claim 29, wherein the status region has a size and/or position that is adjusted based on content displayed within the status region.

32. The method of claim 27, further comprising:
while receiving the transfer of the respective content, detecting a user input at a location that corresponds to the transfer indicator; and
in response to detecting the user input, causing display of additional transfer information via the display generation component.

33. The method of claim 24, further comprising:
while receiving the transfer of the respective content, detecting a user input; and
in response to detecting the user input, performing an operation that corresponds to the user input.

34. The method of claim 24, further comprising, in response to completion of the transfer of the respective content:
in accordance with the determination that the transfer does not meet the one or more transfer magnitude criteria, causing an option to be displayed via the display generation component, wherein the option, when selected, causes display of at least a portion of the respective content via the display generation component.

35. The method of claim 34, further comprising:
detecting a user input corresponding to the option; and
in response to detecting the user input:
in accordance with a determination that the user input has a first input type, causing display of at least a portion of the respective content in a first application; and
in accordance with a determination that the user input has a second input type, causing display of an option to view the respective content in a second application.

36. The method of claim 24, wherein the transfer is performed via a short-range device-to-device communication protocol.

37. The method of claim 24, further comprising:
in accordance with a determination that the first electronic device and the second electronic device are associated with a same user account, initiating the transfer without requesting permission from a user of the first electronic device.

38. The method of claim 24, further comprising:
in accordance with a determination that the first electronic device and the second electronic device are not associated with a same user account, causing display of an option to permit the transfer via the display generation component;
detecting a user input corresponding to selection of the option to permit the transfer; and
initiating the transfer in response to detecting the user input corresponding to selection of the option to permit the transfer.

39. The method of claim 38, wherein the option to permit the transfer is displayed on a wake screen of the first electronic device.

40. The method of claim 24, further comprising:
in response to completion of the transfer of the respective content:
in accordance with the determination that the transfer meets the one or more transfer magnitude criteria and a determination that an application associated with the respective content is active, causing display of an option to view the respective content using the application.

41. The method of claim 24, further comprising, in response to completion of the transfer of the respective content:
causing display of a notification via the display generation component, the notification including an option to share content from the first electronic device.

42. An electronic device, comprising:
one or more processors; and
memory storing one or more programs, wherein the one or more programs are configured to be executed by the one or more processors, the one or more programs including instructions for:
receiving a transfer of respective content from a second electronic device via a local connection; and
in response to completion of the transfer of the respective content:
in accordance with a determination that the transfer meets one or more transfer magnitude criteria, automatically causing display of at least a portion of the respective content via a display generation component; and
in accordance with a determination that the transfer does not meet the one or more transfer magnitude criteria, forgoing automatically causing display of the at least a portion of the respective content via the display generation component.

43. A computer readable storage medium storing one or more programs, the one or more programs comprising instructions that, when executed by an electronic device, cause the electronic device to:
receive a transfer of respective content from a second electronic device via a local connection; and
in response to completion of the transfer of the respective content:
in accordance with a determination that the transfer meets one or more transfer magnitude criteria, automatically cause display of at least a portion of the respective content via a display generation component; and
in accordance with a determination that the transfer does not meet the one or more transfer magnitude criteria, forgo automatically causing display of the at least a portion of the respective content via the display generation component.

44-77. (canceled)
